(19) United States
(12) Patent Application Publication
(10) Pub. No.: US 2026/0292549 A1
(43) Pub. Date: Sep. 24, 2026

(54) LCM FOR AI/ML MOBILITY APPLICABILITY DETERMINATION AND FUNCTIONALITY ACTIVATION

(71) Applicant: InterDigital Patent Holdings, Inc., Wilmington, DE (US)

(72) Inventors: Oumer Teyeb, Montreal (CA); Aristeidis Seretis, Outremont (CA); Patrick Tooher, Montreal (CA); Dylan Watts, Montreal (CA)

(73) Assignee: InterDigital Patent Holdings, Inc., Wilmington, DE (US)

(21) Appl. No.: 19/088,550

(22) Filed: Mar. 24, 2025

(51) Int. Cl. H04W 24/08; H04W 8/22; H04W 24/02

(52) U.S. Cl. CPC H04W 24/08; H04W 8/22; H04W 24/02

(57) ABSTRACT

A wireless transmit/receive unit (WTRU) may receive a measurement prediction configuration that may comprise a first indication. The first indication may indicate that the WTRU is to perform radio resource management (RRM) measurements for one or more cells or that the WTRU is to predict RRM measurements for one or more cells. The measurement prediction configuration may comprise one or more measurement objects. Each of the one or more measurement objects may comprise information associated with the RRM measurements to be performed and/or to be predicted. The WTRU may determine the applicability of the AI/ML model to predict RRM measurements on each of the one or more cells based on the first indication indicating that a RRM measurement is to be predicted.

### BACKGROUND

A release (rel)-19 radio access network 2 (RAN2) study item (SI) on artificial intelligence or machine learning (AI/ML) mobility enhancements has been approved. The main use cases are radio resource management (RRM) measurement prediction and/or measurement event prediction. The study of the use cases is driven mainly by two study goals: First, measurement reduction. Measurement reduction may focus on reducing measurement efforts in temporal, spatial, and/or frequency domain by using predicted measurements. Second, improving handover (HO) performance. This area may improve system and/or wireless transmit/receive unit (WTRU), also known as a user equipment (UE), level performance (e.g., preventing and/or reducing ping-pong HOs, handover failure (HOF), radio link failures (RLFs), short time of stay in a given cell, and/or reducing handover interruption time, etc.) by using predicted measurement reports and/or events.

For the case of RRM measurement prediction, three sub use cases may be considered. In sub-use case 1, layer 1 (L1) beam-level measurement result(s) may be predicted based on actual L1 beam-level measurement result(s). Then, L3 cell-level measurement results may be generated. In sub-use case 2, L3 cell-level measurement result(s) is predicted based on actual L3 cell-level measurement result(s). In sub-use case 3, L3 cell-level measurement result(s) may be predicted based on actual L1 beam-level measurement result(s).

### SUMMARY

A wireless transmit/receive unit (WTRU) may send a capability report. The capability report may comprise information associated with a capability of the WTRU to perform a radio resource management (RRM) measurement prediction associated with an artificial intelligence or machine learning (AI/ML) model. The WTRU may receive a measurement prediction configuration. The measurement prediction configuration may comprise a first indication. The first indication may indicate that the WTRU is to perform RRM measurements for one or more cells or that the WTRU is to predict RRM measurements for one or more cells. The measurement prediction configuration may comprise one or more measurement objects. Each of the one or more measurement objects may comprise information associated with the RRM measurements to be performed and/or to be predicted.

The WTRU may determine the applicability of the AI/ML model to predict RRM measurements on each of the one or more cells based on the first indication indicating that a RRM measurement is to be predicted. The WTRU may send an applicability report. The applicability report may comprise a second indication indicating the applicability of the AI/ML model for each of the one or more cells based on the first indication indicating that the RRM measurement is to be predicted.

The WTRU may perform RRM measurements on each of the one or more cells based on the first indication indicating that the RMR measurement is to be performed. The WTRU may perform RRM measurements based on the measurement objects and/or the information associated with the RRM measurements to be performed. The WTRU may perform RRM measurement predictions on each of the one or more cells based on the applicability of the AI/ML model to predict RRM measurements on each of the one or more cells. The WTRU may perform RRM measurements based on the measurement objects information associated with the RRM measurements to be predicted.

The WTRU may send a measurement report indicating the RRM measurements associated with each of the one or more cells and/or the predicted RRM measurements associated with each of the one or more cells.

The WTRU may receive, after the WTRU sends the capability report, a configuration indicating the one or more cells that the RRM measurement is to be predicted. The WTRU may monitor the applicability of the AI/ML model to predict RRM measurements on each of the one or more cells. The WTRU may send an applicability change report, wherein the applicability change report comprises updates to the applicability of the AI/ML model on each of the one or more monitored cells. The information associated with the capability of the WTRU to perform a RRM measurement prediction may comprise one or more of an indication the WTRU can perform AI/ML prediction for the one or more cells, a list of the one or more cells, tracking areas, measurement reduction rate (MRRT) skipping patterns, an observation window (OW) lengths, and/or prediction window (PW) lengths. The OW and PW lengths can be absolute time durations (e.g., OW window of 400 ms, PW of 200 ms, etc.) or based on the number of measurement samples (e.g., an OW of 10 measurement samples, a PW of 5 measurement samples, etc.). The WTRU may be configured with a measurement sampling period, and thus an OW/PW specified in terms of absolute time durations can be mapped to a number of measurement samples, or an OW/PW specified in terms of measurement samples can be mapped to absolute time durations.

The information associated with the RRM measurements to be performed or to be predicted may comprise one or more of cell level measurement derivation parameters, L3 filtering coefficients, L3 filtering parameters, a measurement reduction rate (MRRT), a measurement skipping pattern, a measurement skipping periodicity, a measurement skipping offset, an observation window (OW) length, a prediction window (PW) lengths, an OW periodicity, a PW periodicity, an OW offset, a PW offset, one or more identifiers (IDs) for the one or more cells the RRM measurement is to be performed, one or more IDs for the one or more cells the RRM measurements is to be predicted, and/or a minimum performance level for the RRM measurement to be predicted.

The cell level measurement derivation parameters may comprise measured cell and/or beam signal levels and predicted cell or beam signal levels. The L3 filtering parameters may comprise measured cell and/or beam signal levels, predicted cell and/or beam, and predicted cell and/or beam signal levels.

The AI/ML model may determine to be applicable based on one or more of the AI/ML model being configured to perform RRM measurement prediction, the AI/ML being trained for current WTRU conditions, the AI/ML model being trained to a specific area associated with the one or more cells the RRM measurement is to be predicted, the AI/ML model support for measurement prediction related parameters, and/or the tests performed by the AI/ML model used to provide key performance indicators (KPIs).

The measurement prediction configuration may further comprise one or more reporting configurations associated with the one or more measurement objects and/or one or more measurement identities (IDs).

The one or more reporting configurations may comprise one or more of periodicity, event thresholds, time to trigger (TTT), hysteresis, and/or conditional handover (CHO) configuration.

The applicability report may further comprise a third indication that RRM measurement is to be predicted based on a configuration of the one or more measurement objects. In some examples, the applicability report may indicate applicability at measurement object level.

A measurement object may be used to include measurement information and/or prediction information. The WTRU may be configured with multiple AI/ML models and the WTRU may be configured to determine the applicability across each or all AI/ML models. For example, the WTRU may have two AI/ML models, one applicable for doing measurements for certain frequencies and a second that is applicable for other frequencies, and if the WTRU is configured to predict both frequencies, the WTRU may use both AI/ML models at the same time. In such examples, the WTRU may send a single applicability report (e.g., that indicates to the network that the WTRU can perform the prediction or inference using at least one AI/ML model).

In some examples, a wireless transmit/receive unit (WTRU) may be configured to receive a measurement prediction configuration. The measurement prediction configuration may include a first indication that indicates that the WTRU is to perform radio resource management (RRM) measurements for one or more cells or that the WTRU is to predict RRM measurements for one or more cells. The measurement prediction configuration may include one or more measurement objects. The measurement objects may include information associated with the one or more cells associated with the RRM measurements to be performed. The measurement objects may include information associated with the one or more cells associated with the RRM measurements to be predicted. The measurement objects may include information indicating how the prediction is to be performed;

The WTRU may send an applicability report. The applicability report may include a second indication indicating that the WTRU can perform the prediction for RRM measurements for the one or more cells and/or for the one or more measurement objects. The WTRU may perform RRM measurements associated with the one or more cells based on the first indication indicating that the RRM measurement is to be performed and based on the measurement prediction configuration. The WTRU may perform RRM measurement predictions associated with each of the one or more cells based on the measurement prediction configuration. The WTRU may send a measurement report indicating the RRM measurements associated with the one or more cells and the predicted RRM measurements associated with the one or more cells.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example diagram of intra-frequency temporal domain case A.

FIG. 3 depicts an example diagram of intra-frequency temporal domain case B.

FIG. 4 depicts another example diagram of intra-frequency temporal domain case B.

FIG. 5 depicts an example diagram of indirect measurement event prediction.

FIG. 6 depicts an example diagram of direct measurement event prediction.

FIG. 7 depicts a diagram of life cycle management (LCM) signaling for beam management use case.

FIG. 8 depicts a diagram of a reactive solution wherein the wireless transmit/receive unit (WTRU) determines to start performing the measurements and/or measurement prediction according to the configurations.

FIG. 9 depicts a diagram of a proactive solution wherein the WTRU determines to start performing the measurements and/or measurement prediction according to the configurations.

FIG. 10 depicts a diagram of a combined reactive and proactive solution wherein the WTRU determines to start performing the measurements and/or measurement prediction according to the configurations.

FIG. 11 depicts a diagram of a high-level new radio (NR) measurement model.

### DETAILED DESCRIPTION

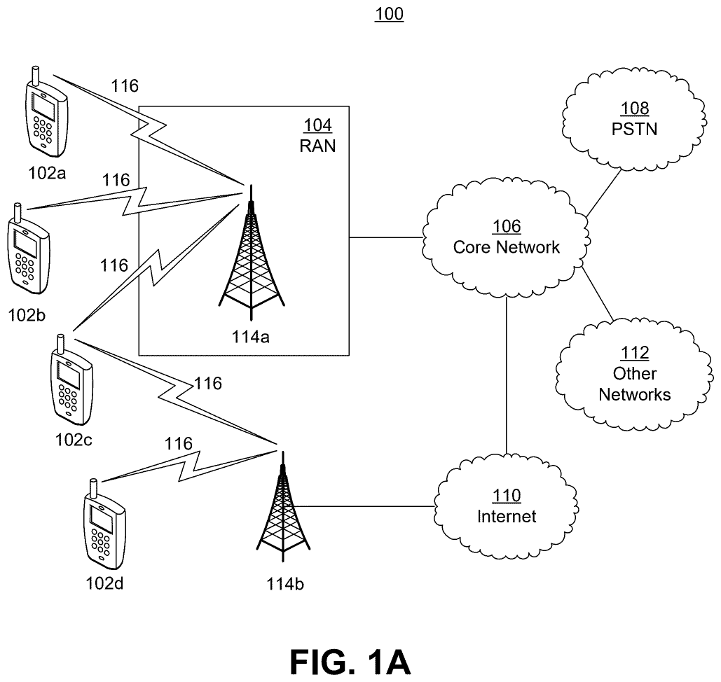

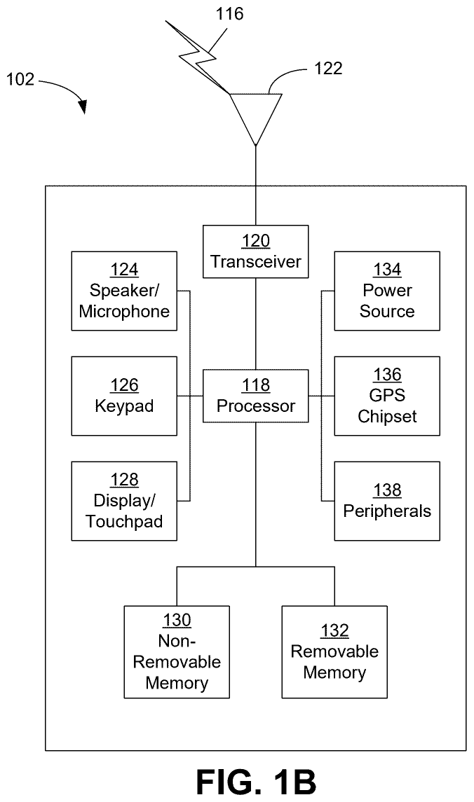

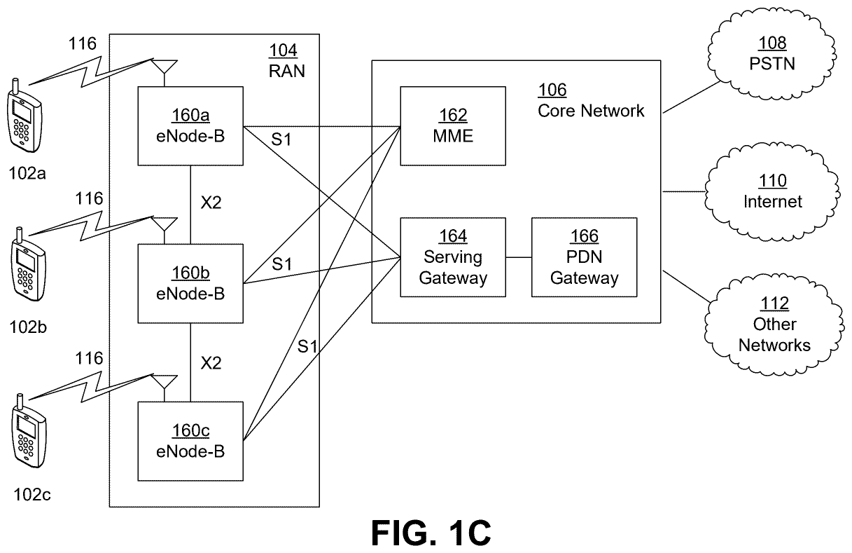

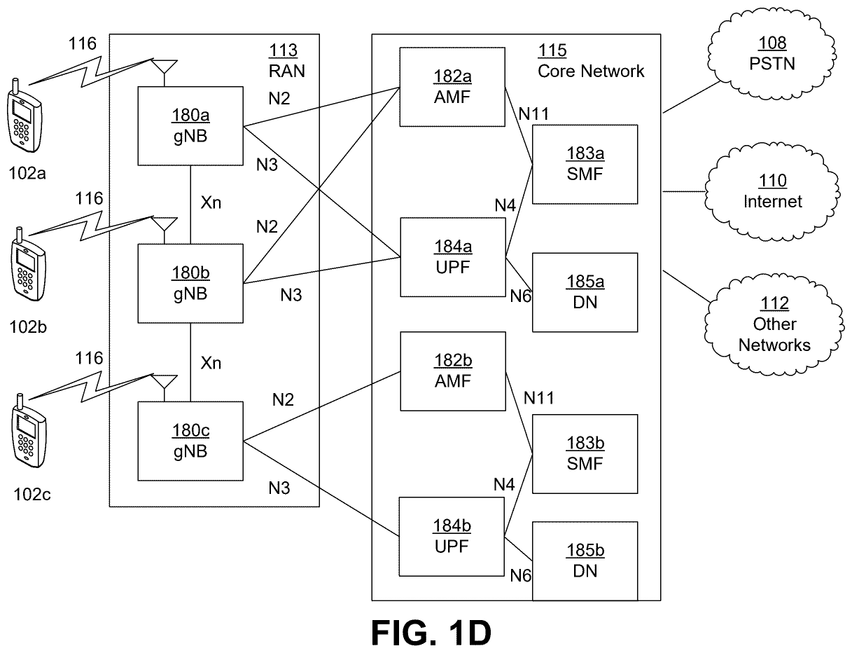

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A release (rel)-19 radio access network 2 (RAN2) study item (SI) on artificial intelligence or machine learning (AI/ML) mobility enhancements has been approved. The main use cases are radio resource management (RRM) measurement prediction and/or measurement event prediction. The study of the use cases is driven mainly by two study goals: first, measurement reduction. Measurement reduction may focus on reducing measurement efforts in temporal, spatial, and/or frequency domain by using predicted measurements. Second, improving handover (HO) performance. This area may improve system and/or UE level performance (e.g., preventing and/or reducing ping-pong HOs, handover failure (HOF), radio link failures (RLFs), short time of stay in a given cell, and/or reducing handover interruption time, etc.) by using predicted measurement reports and/or events.

For the case of RRM measurement prediction, three sub use cases may be considered. In sub-use case 1, layer 1 (L1) beam-level measurement result(s) may be predicted based on actual L1 beam-level measurement result(s). Then, L3 cell-level measurement results may be generated. In sub-use case 2, L3 cell-level measurement result(s) is predicted based on actual L3 cell-level measurement result(s). In sub-use case 3, L3 cell-level measurement result(s) may be predicted based on actual L1 beam-level measurement result(s).

Measurement prediction accuracy for cell-level RRM measurement prediction may be defined as average L3 reference signal received power (RSRP) difference between predicted L3 filtered cell-level measurement result and actual L3 filtered cell-level measurement result of the same cell for all RRM sub-use cases.

Measurement reduction rate for intra-frequency scenario(s) may be defined in the temporal domain (called MRRT). MRRT may be defined as skipped measurement time instances divided by total measurement time instances. Here, it may be assumed that the same length of measurement time instances and spatial domain respectively (called MRRS). MRRS may be defined as skipped beams to be measured divided by total beams to be measured.

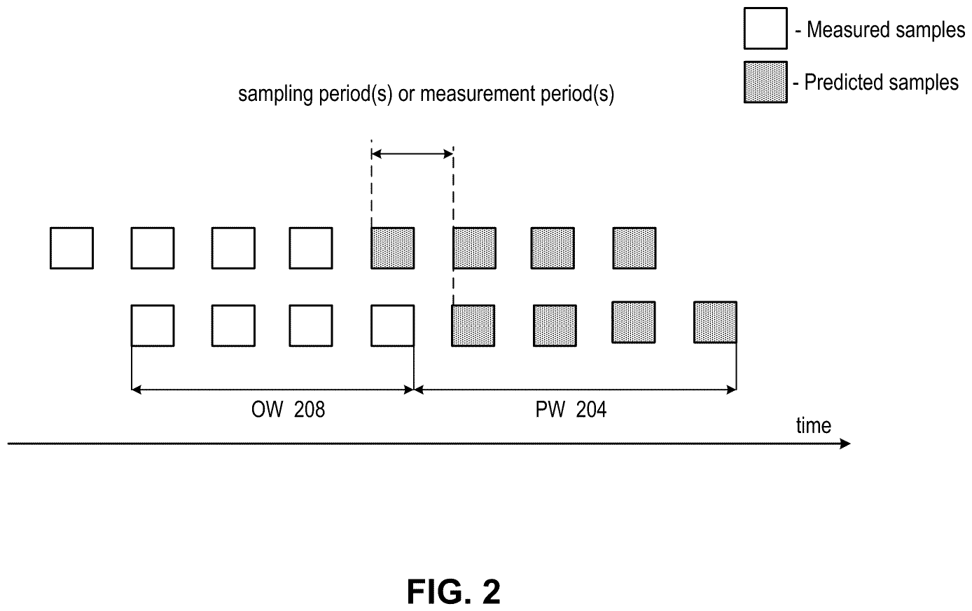

FIG. 2 depicts an example diagram of intra-frequency temporal domain case A. In intra-frequency temporal domain case A, continuous measurement may result in prediction window(s) (PW) 204 predicted by continuous historical measurement result(s) in an observation window (OW) 208. Then, OW and/or PW may slide forward with either sampling period(s) (e.g., with sliding L1/L3 filtering option) and/or measurement period(s) (e.g., with non-sliding L1/L3 filtering option). Measurement result(s) may actually be measured before sliding.

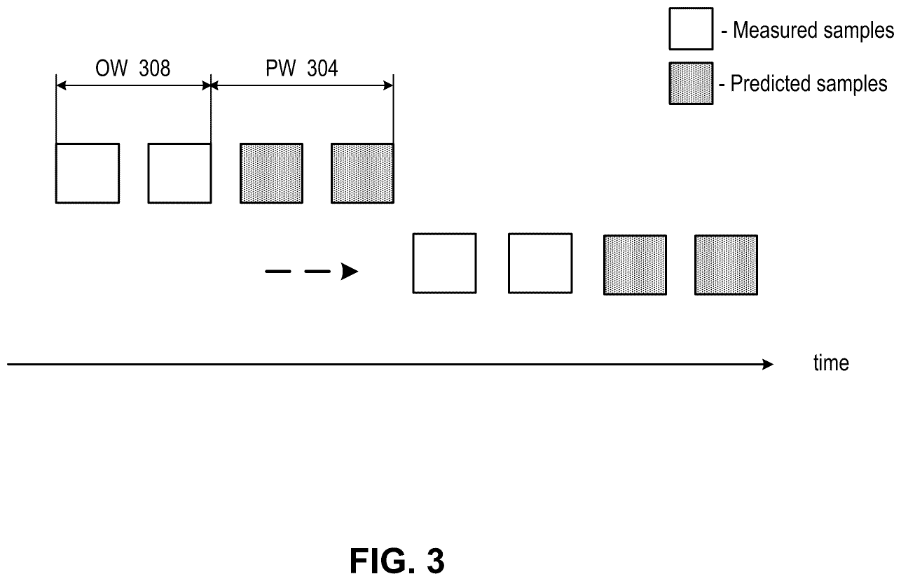

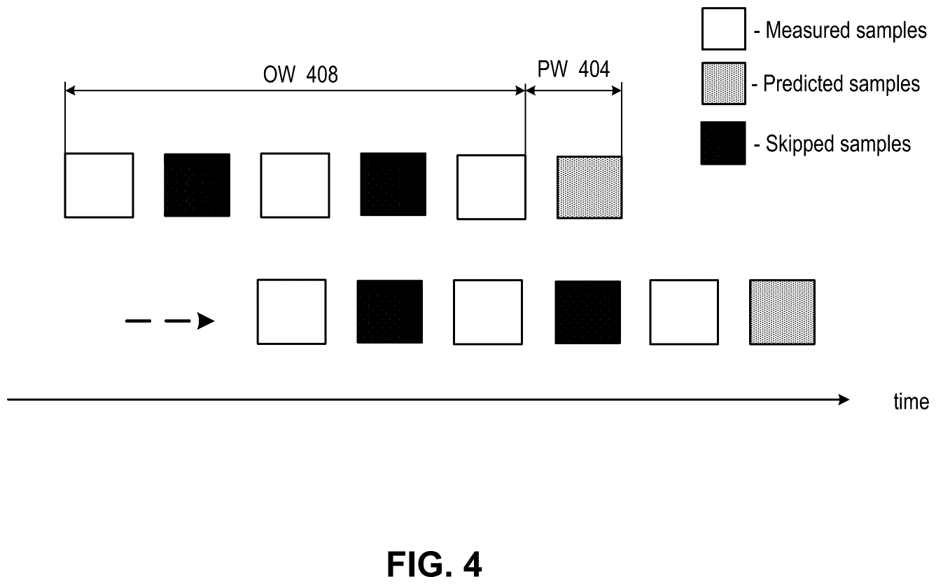

FIGS. 3 and 4 depict example diagrams of intra-frequency temporal domain case B. In intra-frequency temporal domain case B, measurement results in PW 304, 404 may be predicted by historical measurement result(s) in OW 308, 408. Then OW 308, 408 and/or PW 304, 404 may slide forward with either sampling period(s) (e.g., with sliding L1/L3 filtering option) and/or measurement period(s) (e.g., with non-sliding L1/L3 filtering option). Measurement result(s) in previous PW 304, 404 may be skipped during window sliding.

Referencing FIGS. 2, 3, and 4, the diagrams may illustrates measured samples, predicted samples (e.g., that may or may not be measured in the future based on the RRM sub-functionality (e.g., in RRM reduction they are skipped, in RRM event prediction they are eventually measured)), and samples that are skipped (e.g., applicable when (e.g., only when) RRM reduction is used).

Intra-frequency intra-cell spatial domain prediction may be evaluated for the first study goal (measurement reduction) by measuring a subset of configured synchronized signature blocks (SSBs) as input to the model to derive L3 filtered cell-level measurements for every time instance of the same cell. Intra-frequency intra-cell spatial domain prediction may be evaluated for frequency range 2 (FR2) intra-frequency scenario. Intra-frequency intra-cell spatial domain prediction may be applicable for RRM sub-use cases 1 and/or 3.

For both Intra-frequency prediction inter-cell prediction and FR1 to FR1 inter-frequency inter-cell prediction, no measurement is reduced in both temporal and spatial domain for the cell to be measured. For FR1-to-FR1 inter-frequency inter-cell prediction, the focus may be on the case where the cell to be measured and/or predicted are located in the same sector of either a serving site or a same neighboring site. FR1 to FR1 inter-frequency inter-cell prediction may be applicable for all RRM sub-use cases.

Intra-frequency inter-cell prediction may refer to neighboring cell prediction based on measurements of either co-located and/or non-collocated serving cell and/or a neighboring cell.

The prioritization among evaluation scenarios in rel-19 is depicted in Table 1, see below:

| | | | Target | |
|---|---|---|---|---|
| scenario | | | study | |
| number | Priority | Evaluation scenario | goal | Methodology |
| 1 | Low | FR1 to FR1 intra-frequency | 2^{nd} goal | TBD |
| | | temporal domain case A | | |
| 2 | High | FR1 to FR1 intra-frequency | 1^{st} goal | Intra-cell |
| | | temporal domain case B | | |
| 3 | High | FR1 to FR1 inter-frequency | 1^{st} goal | Inter-cell |
| | | (frequency domain) | | |
| 4 | High | FR2 to FR2 intra-frequency | 2^{nd} goal | Intra-cell |
| | | temporal domain case A | | |
| 5 | Low | FR2 to FR2 intra-frequency | 1^{st} goal | TBD |
| | | temporal domain case B | | |
| 6 | Middle | FR2 to FR2 intra-frequency | 1^{st} goal | Intra-cell |
| | | spatial domain | | |

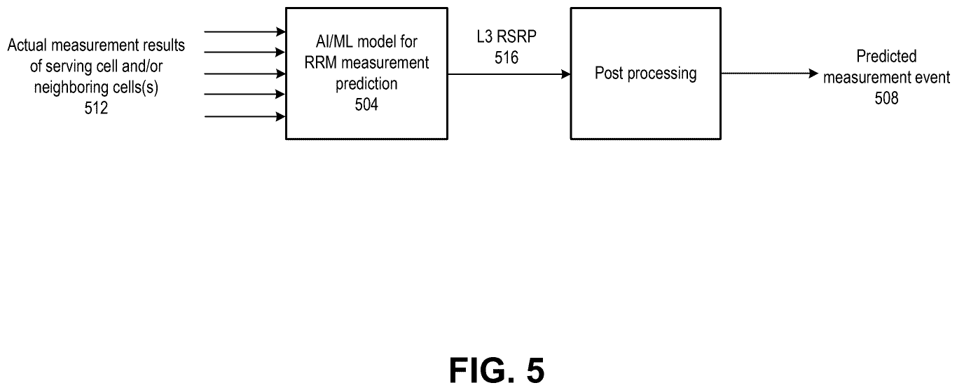

For measurement event prediction, two sub uses may be considered: indirect prediction and direct prediction. FIG. 5 depicts an example diagram of an indirect measurement event prediction. In indirect prediction, an AI/ML model 504 may be first used to predict the cell level measurements 508 (of serving and/or neighboring cells). The predicted and/or actual historical measurements 512 may be used in predicting a measurement event (e.g., serving and/or neighbor cell is better/worse than a certain RSRP 516 threshold, and/or serving cell is worse or better than a neighbor by more than a certain RSRP 516 threshold, etc.) will happen at a given time instance.

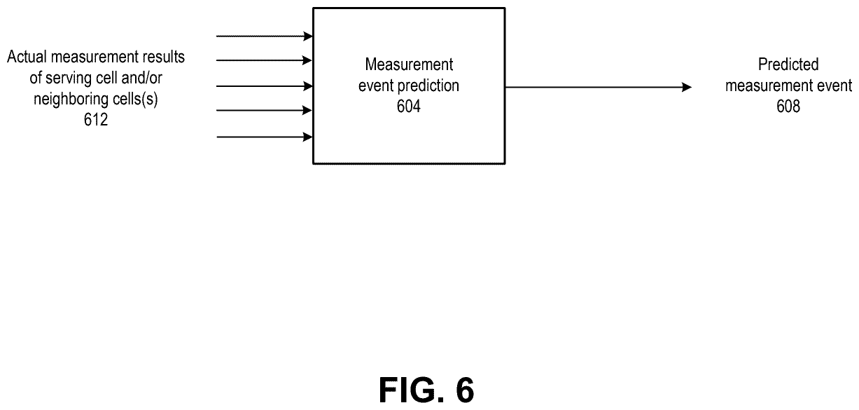

FIG. 6 depicts an example diagram of a direct measurement event prediction. In direct prediction, an AI/ML model 604 may directly predicts whether a measurement event 608 is expected to happen within a given time window (e.g., without intermediate prediction of the measurements of serving and/or neighbor cells 612).

AI/ML operations may be based on models (e.g., neural networks) that have been trained using a substantial amount of data under different scenarios and/or conditions. The conditions may be WTRU side conditions (e.g., speed) and/or network side conditions (e.g., antenna pattern, and/or load, etc.). These are referred to as WTRU side additional conditions and network side additional conditions, respectively.

For a given AI/ML functionality, there may be several models (e.g., each trained and/or suitable for different network and/or WTRU side additional conditions). Once a model is well trained, the model may be deployed (e.g., in a test environment and/or network) for performance testing. Model monitoring may need to be performed even after deployment in a real network, as the current network and/or WTRU conditions can become different from the scenarios/conditions in which the model was trained and/or tested. If the model monitoring is shown to provide undesirable network and/or WTRU performance, a decision may be made to switch to another model and/or stop using AI/ML based operations for the concerned function. The performance monitoring may determine whether a model needs to be retrained with new sets of data. Model training and/or monitoring may be performed at the WTRU, at the network, and/or in collaboration between the two. Model training and/or monitoring may be performed offline or online. All the different aspects discussed above for enabling the working of an AI/ML functionality may be collectively referred to as life cycle management (LCM).

In the context of AI/ML for a beam management use case, the Third Generation Partnership Project (3GPP) has been discussing the applicability determination and/or functionality activation. Currently, the radio access network (RAN) 2 is agreed upon, with the following understandings on terminologies: supported functionalities may refer to functionalities that WTRU can indicate by using WTRU capability information, e.g. via radio resource control (RRC) and/or long term evolution positioning protocol (LPP) signaling. Applicable functionalities may refer to functionalities that the WTRU is ready to apply for inference. Activated functionalities may refer to functionalities already enabled for performing inference.

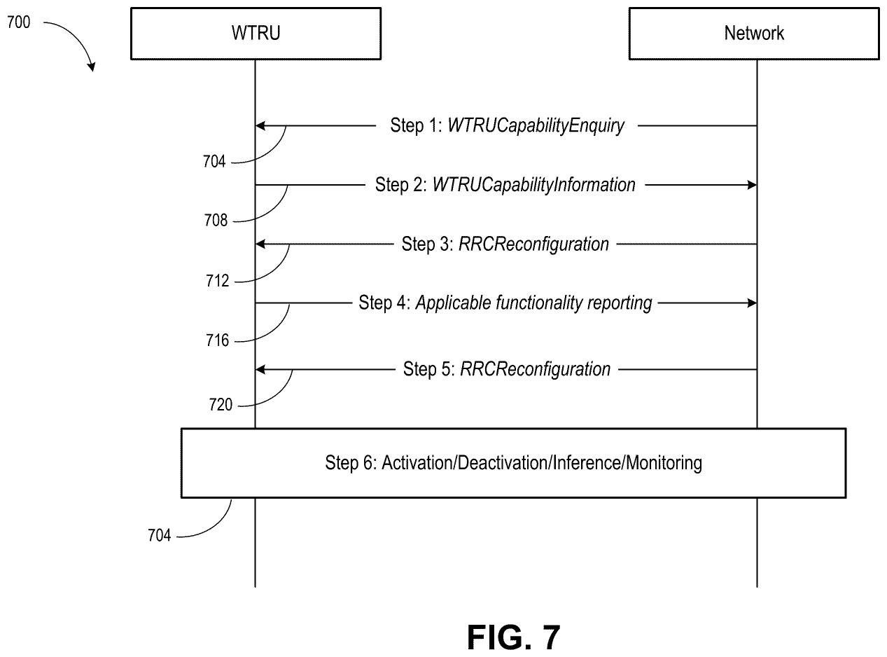

FIG. 7 depicts an LCM signaling procedure 700 for the beam management use case. As illustrated in FIG. 7, at 704, the network may send a UECapabilityEnqiry message to initiate the procedure to a WTRU reporting its AI/ML supported functionalities. At 708, the WTRU may send a UECapablityInformation message to network. The UECapablityInformation message may contain supported functionalities at the WTRU side. At 712, the following configurations are provided from NW to WTRU: the WTRU may be allowed to perform UE assistance information (UAI) reporting via OtherConfig; and/or the network may provide network (NW)-side additional condition.

The WTRU may decide the applicable functionalities based on NW-side additional conditions (if provided), the WTRU-side additional conditions (internally known by the WTRU), and/or model availability in device (not pictured in FIG. 7.).

At 716, the WTRU may report the applicable functionality in the following scenarios: upon being configured to provide applicable functionality and/or upon change of applicable functionality via UAI; and/or as a response to NW-side additional condition requesting applicable functionality reporting at 712, FFS other network configuration (e.g. inference configuration).

At 720, the network may configure inference configuration to the WTRU after applicable functionality reporting if inference configuration based on supported functionality is not provided in at 712 (e.g., inference configuration is provided at 720). Further, at 720, if inference configuration based on supported functionality is provided in 712, network implementation may determine to provide an updated configuration (e.g., via an RRCReconfiguration message). At 724, the WTRU may activate and/or deactivate inference and/or monitoring. Similarly, the network may activate and/or deactivate inference and/or monitoring.

Some of the signaling components that have been agreed for the beam management case described above may be adopted for the case of LCM for the AI/ML mobility use case (e.g., RRM measurement prediction and/or measurement event prediction). However, fundamental differences between the beam management use case and the AI/ML mobility use case may require consideration. This may be primarily due to the mobility use case involving the measurement and/or event prediction of several cells while the beam management use case mainly concerns operation within a given cell. Some of the implications of these may include: for mobility purposes, the WTRU may need to be configured to measure and/or predict the measurements of serving and/or neighbor cells. These different serving and/or neighbor cells may operate at different frequencies and/or have different network configurations, etc. Accordingly, at a given time, the WTRU may perform predictions for some of the cells but not for others.

The configuration required for performing RRM measurements (and related event determination) and/or corresponding measurement and/or event prediction may be fundamentally different from the CSI-RS reporting configuration used for beam management. This may impact how and/or when the inference configuration can be provided to the WTRU, the components of this inference configuration, and/or when to perform the functionality activation.

The WTRU may have the same or different models for doing the predictions of the concerned cells. For example, in case different models may have to be used for the different cells, there may be a limitation in the number of models the WTRU may activate and/or use at the same time and/or also the number of cells the WTRU may measure at the same time.

Described herein are methods and/or implementations to enhance the current agreed LCM framework for the beam management use case. Moreover, described herein are methods and/or implementations to support the applicability determination and/or activation and/or deactivation of AI/ML based RRM measurement and measurement event prediction.

A WTRU may perform AI/ML based RRM measurement prediction and/or measurement event prediction. The configuration may contain information regarding the measurements to be performed, and/or predicted. The configuration may indicate if the predicted measurements may be skipped as well as the skipping pattern). The configuration may contain information about the network side conditions (e.g., associated IDs) of the different serving and/or neighbor cells where measurement prediction is to be performed. The configuration may include an indication whether measurement is to be performed if prediction is not applicable. The WTRU may determine if it can apply the configuration (e.g., the WTRU has a model for the concerned cells to be measured that is compatible with the current WTRU side conditions and indicated network side conditions). The WTRU may inform the network about the applicability (e.g., fully applicable, partially applicable only to some of the cells corresponding to a measurement object, and/or not applicable to all the cells corresponding to a measurement object, etc.) and/or reason for non-applicability. For those configurations that are applicable, the WTRU may start performing the measurements and/or measurement prediction according to the configurations.

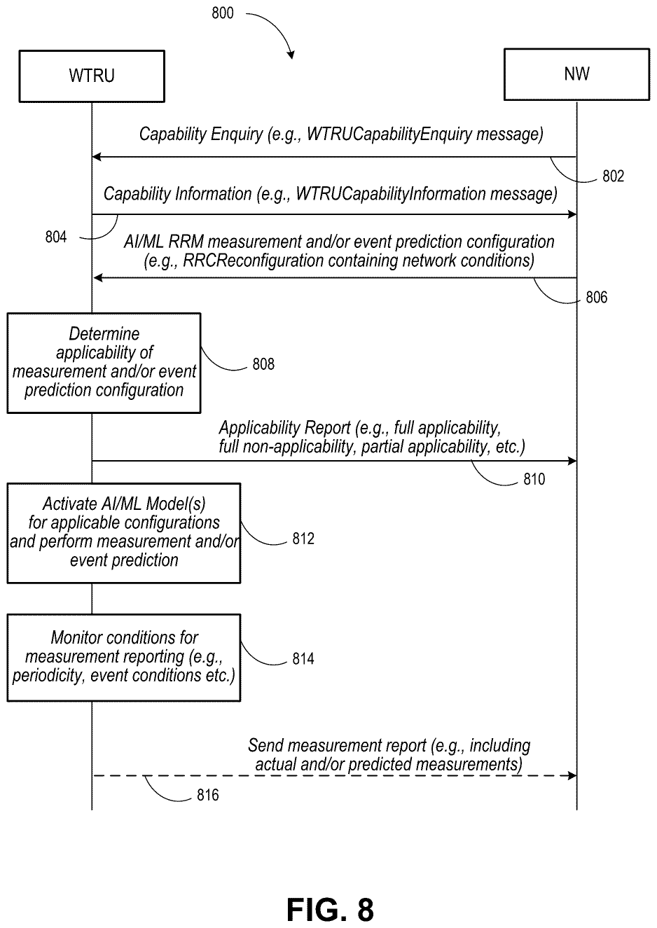

FIG. 8 depicts a diagram of an example procedure 800 (e.g., a reactive solution) wherein the WTRU determines to start performing the measurements and/or measurement prediction according to the configurations. At 802, the WTRU may receive a capability enquiry (e.g., WTRUCapabilityEnquiry message). At 804, the WTRU may capability information (e.g., WTRUCapabilityInformation message) to the network. For example, the WTRU may send a WTRU capability report to the network indicating support for AI/ML based RRM measurement prediction.

At 806, the WTRU may receive an AI/ML RRM measurement and/or event prediction configuration (e.g., RRCReconfiguration containing network conditions). For example, the WTRU may receive a configuration to perform RRM measurements and/or measurement predictions. The configuration may contain one or more measurement objects (and/or associated reporting configurations). Each measurement object may correspond to one or more serving and/or neighbor cells at a given frequency. Each measurement object may contain one or more of the following information related to measurements to be performed and/or measurements to be predicted: parameters such as frequency, subcarrier spacing, cell level measurement derivation parameters (e.g., beams to consolidate and/or beam selection threshold, etc.), L3 filtering parameters and/or coefficients, allowed and/or blocked cells, and/or measurement cycle, etc.

The parameters may be related to measurement prediction such as cell level measurement derivation parameters that consider measured cell/beam signal levels and predicted cell and/or beam signal levels, L3 filtering coefficient/parameters that consider measured cell and/or beam signal levels and predicted cell/beam and predicted beams/cell signal levels, measurement reduction rate (MRRT), measurement skipping pattern and/or periodicity and/or offset, OW and/or PW window lengths and/or periodicity and/or offsets, and/or indications as to whether measurement is to be performed if prediction cannot be applied, etc.

Measurement objects may also comprise information related to network side conditions (e.g., associated IDs for one or more of the serving/neighbor cells configured to be measured/predicted); a minimum performance level for the predictions (e.g., key performance indicators (KPI) threshold related to measurement prediction accuracy, and/or F1-score, etc.); and/or associated reporting configuration (e.g., periodic reporting and/or event based reporting, etc.)

At 808, the WTRU may determine applicability of measurement and/or event prediction configuration. For example, for the measurement objects that indicate measurement prediction is to be performed, the WTRU may perform AI/ML applicability determination. Therein, the WTRU may consider the prediction configuration for the measurement object is applicable if one or more of the following are fulfilled: the WTRU has at least one model for RRM measurement prediction; the model is trained for the current WTRU conditions (e.g., current WTRU speed); the model is trained for the concerned cell whose measurement is being (partially or fully) being predicted (e.g., model is trained for a specific area that the concerned cell is part of, model is specifically trained for the cell, and/or model is trained for the cell while that cell is operating under the indicated associated ID, etc.); the model supports the indicated measurement prediction related parameters (e.g., MRRT, skipping pattern, and/or OW and/or PW window lengths, etc.); and/or the model has been tested to provide the indicated KPI level.

At 810, the WTRU may send to the network an AI/ML applicability report. For example, the WTRU send an applicability Report (e.g., full applicability, full non-applicability, partial applicability, etc.). The applicability report may indicate one or more of the following concerning each measurement object that indicates measurement prediction is to be made: that a prediction may be made according to the configuration for the measurement object.

The applicability report may further indicate that a prediction cannot be made for one or more serving or neighbor cells (e.g., fully or partially) according to the configuration, and/or including the cause, value, and/or reason for not performing measurements. Such causes, values, and/or reasons may include the following: the model not available for one or more of the cells corresponding to the measurement object; model not trained for one or more of the cells corresponding to the measurement object; model available and/or trained but not for the current network condition (e.g., associated ID) for one or more of the cells corresponding to the measurement object; model available and/or trained but not for the current WTRU conditions; model available and/or trained but not able to operate under the configured prediction configuration (e.g., MRRT, OW and/or PW length, and/or skipping pattern, etc.); model available and/or trained, but not expected to provide the indicated performance level.

At 812, the WTRU may activate AI/ML Model(s) for applicable configurations and perform measurement and/or event prediction. At 814, the WTRU may monitor conditions for measurement reporting (e.g., periodicity, event conditions etc.). For example, for those measurement objects and/or reporting configurations that are applicable, the WTRU may start performing the measurements and/or measurement predictions according to the received configuration. The WTRU may send a measurement report when the reporting conditions are fulfilled.

In summary, a WTRU may do the following: a WTRU may send a WTRU capability report to the network indicating support for AI/ML based RRM measurement prediction. The WTRU may receive a configuration related to RRM measurements. The configuration contains one or more of the following: a configuration for performing RRM measurements for one or more cells and/or a configuration for predicting RRM measurements for one or more cells (e.g., network side additional conditions for the concerned cells to be measured, measurement reduction rate, measurement skipping pattern and/or OW and/or PW lengths, etc.).

The WTRU may determine AI/ML applicability for one or more or all of the cells where measurement prediction is configured. The prediction may be considered applicable if an AI/ML model is trained for one, more, or all cells under the indicated network side and/or additional conditions and/or can operate under the prediction configuration (e.g., measurement reduction rate, skipping pattern, and/or OW and/or PW window lengths, etc.).

The WTRU may send to the network a cell level applicability report that may indicate the determined AI/ML applicability of one or more cells (e.g., if prediction can be made according to the received configuration for that cell). If the AI/ML model is not applicable, the applicability report may provide the reason for non-applicability.

The WTRU may start performing measurements for those cells it is configured to perform actual measurements and/or measurement prediction for those cells where prediction is applicable. The WTRU may send a measurement report when the measurement reporting conditions are fulfilled (e.g., periodically and/or upon event fulfillment, etc.).

An alternate solution, or proactive solution is also disclosed herein.

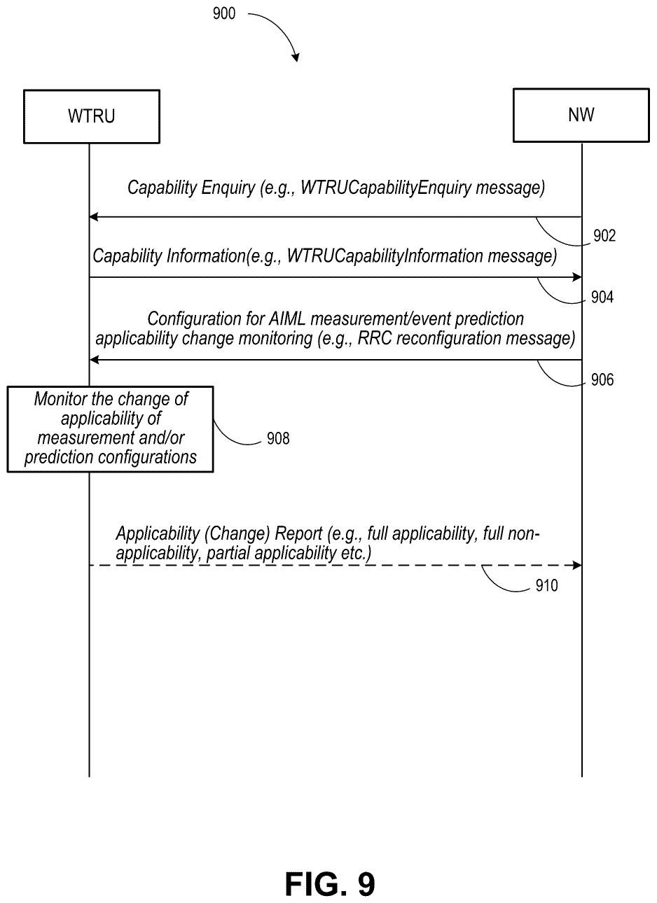

FIG. 9 depicts a diagram of an example procedure 900 (e.g., proactive solution) wherein the WTRU determines to start performing the measurements and/or measurement prediction according to the configurations.

At 902, the WTRU may send a capability enquiry (e.g., WTRUCapabilityEnquiry message) to the network. At 904, the WTRU may receive capability information (e.g., WTRUCapabilityInformation message) from the network. For example, before the WTRU receives a configuration related to RRM measurements, the WTRU may send a detailed information about its capabilities. For example, such capabilities may include the WTRU indicating that it may perform AI/ML prediction for these cells, a list of cells, RAN and/or tracking areas, etc. The WTRU may disclose that it is capable of conducting AI/ML model functions under specified prediction configurations, such as the supported MRRT, skipping patterns, associated IDs, and/or OW/PW lengths, etc. The network may configure the WTRU accordingly based on this input and/or capability disclosure.

At 906, the WTRU may receive a configuration for AIML measurement/event prediction applicability change monitoring (e.g., RRC reconfiguration message) from the network. At 908, the WTRU may monitor the change of applicability of measurement and/or prediction configurations. At 910, the WTRU may send an applicability (e.g., change) report that indicates full applicability, full non-applicability, partial applicability of the WTRU to perform prediction using one or more AI/ML models and/or for one or more cells.

In addition to the one step of applicability determination (applicable/non-applicable) described above, the WTRU may perform proactive applicability reporting. Therein, the WTRU may monitor applicability change for the one or more of the cells or measurement objects and/or report updates (e.g., maybe prediction was not possible when the configuration was received due to WTRU speed, but now WTRU has stopped moving and/or prediction can be made, etc.).

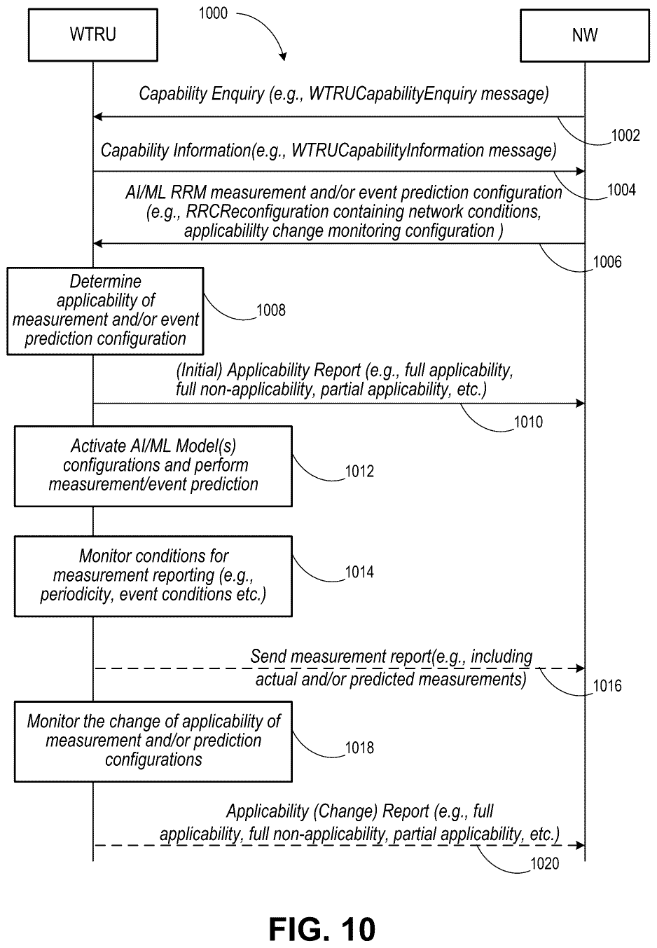

FIG. 10 depicts a diagram of an example procedure 1000 (e.g., a combined reactive and proactive solution) wherein the WTRU determines to start performing the measurements and/or measurement prediction according to the configurations.

At 1002, the WTRU may send a capability enquiry (e.g., WTRUCapabilityEnquiry message) to the network. At 1004, the WTRU may receive capability information (e.g., WTRUCapabilityInformation message) from the network.

At 1006, the WTRU may receive a configuration for AI/ML RRM measurement and/or event prediction configuration (e.g., RRCReconfiguration containing network conditions, applicability change monitoring configuration). At 1008, the WTRU may determine applicability of measurement and/or event prediction configuration(s). At 1010, the WTRU may send an (e.g., initial) applicability report that indicates full applicability, full non-applicability, partial applicability of the WTRU to perform prediction using one or more AI/ML models and/or for one or more cells.

At 1012, the WTRU may activate one or more AI/ML Model(s) configurations and perform measurement and/or event prediction. At 1014, the WTRU may monitor conditions for measurement reporting (e.g., periodicity, event conditions etc.). At 1016, the WTRU may send a measurement report (e.g., including actual and/or predicted measurements). At 1018, the WTRU may monitor the change of applicability of measurement and/or prediction configurations. At 2020, the WTRU may send an applicability (e.g., change) report that indicates a change in the full applicability, full non-applicability, partial applicability of the WTRU to perform prediction using one or more AI/ML models and/or for one or more cells.

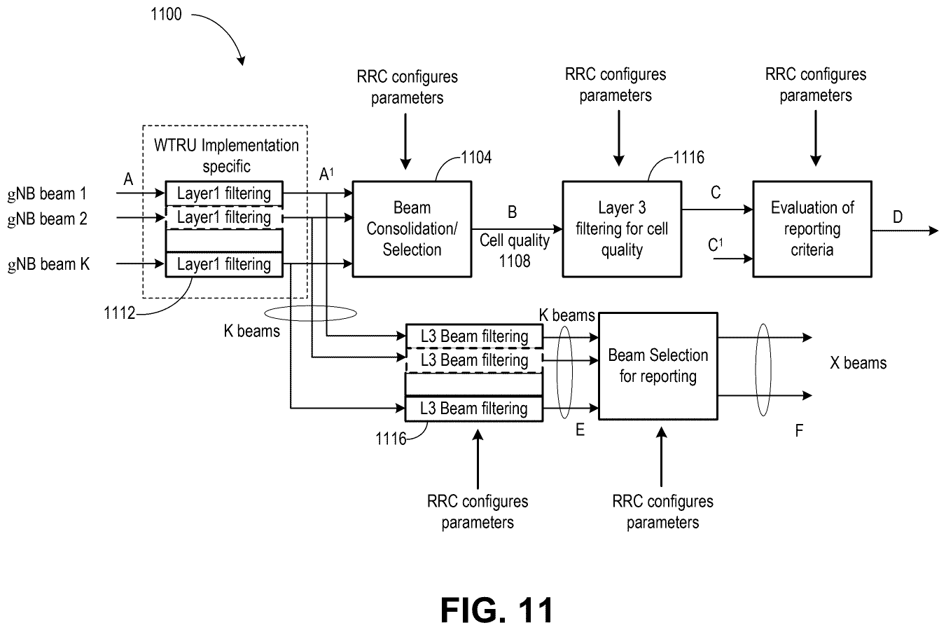

FIG. 11 depicts a diagram 1100 of a high-level new radio (NR) measurement model. In NR, when a WTRU is in RRC_CONNECTED state, that WTRU may measure the signal level of one or more beams of a cell. At 1104, the WTRU may then average the measurement results to derive the cell quality 1108. This is also referred to as beam consolidation 1104. Essentially, this operation amounts to the linear averaging of a maximum number of top beams that have a signal level above a certain threshold. Filtering may take place at two different levels: at the physical layer (L1) level 1112, to derive beam quality; and at RRC (L3) level 1116, to derive cell quality from multiple beams. Cell quality from beam measurements may be derived in the same way for the serving cell(s) and for the non-serving cell(s). Measurement reports may contain the measurement results of the x best beams if the network configures the WTRU to do so.

A WTRU may perform measurements of serving and/or neighbor cells based on a configuration received by the gNB. The WTRU can be configured to report the measurements periodically or when certain events are fulfilled (e.g., A3 event, where a neighbor cell's signal quality becomes better than the serving cell by more than a certain threshold). Based on the measurement reports, the network may send a handover (HO) command to the WTRU indicating for the WTRU to switch the connection to the target cell indicated in the HO command. The network may send a HO command at any time (e.g., without receiving a measurement report) for switching the connection of the WTRU to another cell (e.g., for load balancing purposes).

The WTRU may be configured with a conditional handover (CHO) configuration. The CHO may contain a HO command and/or an associated measurement event. When the measurement event conditions get fulfilled, the WTRU may execute the HO command associated with the event instead of sending a measurement report.

The existing RRM measurement configuration may be comprised of: measurement objects (what is to be measured, e.g., frequency, cells, SSB/CSI-RS config, offsets, measured quantities, and/or cell level measurement derivation parameters, etc.); reporting configurations (what is to be reported and when it is to be reported, e.g., periodicity, event thresholds, time to trigger (TTT), hysteresis, and/or CHO config, etc.); and/or measurement identities (IDs) (e.g., an association of a measurement object with a reporting configuration, such that if there is no measID associated with a measurement object, the WTRU may not perform the measurement according to the measurement object configuration). The terms identifier and identity can be used interchangeably.

The measurement configuration may be provided to the WTRU in an RRCReconfiguration message that contains a MeasConfig IE. The MeasConfig IE may further contain several IEs to configure the measurement objects (e.g., a list of measobjectNR), reporting configurations (e.g., a list of reportingConfigNR), a list of measurement identities that link the measurement objects with reporting configurations (e.g., a list of measID), and/or other relevant information for performing measurements, such as measurement gaps (for inter-frequency measurements), positioning measurement, and/or the filtering coefficients to be applied, etc.

Artificial intelligence (AI) may be broadly defined as the behavior exhibited by machines. Such behavior may, e.g., mimic cognitive functions to sense, reason, adapt and/or act.

Machine learning (ML) may refer to type of algorithms that solve a problem based on learning through experience (e.g., data), without explicitly being programmed (e.g., configuring set of rules). Machine learning may be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. Unsupervised learning approach may involve detecting patterns in the data with no pre-existing labels. Reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard, semi-supervised learning falls between unsupervised learning (with no labeled training data) and supervised learning (e.g., with only labeled training data).

A given AI/ML model may be trained under certain WTRU and/or network side additional conditions. A WTRU side condition may be the speed of the WTRU. On the other hand, network side additional conditions may relate to some network configurations and/or settings that the WTRU may not be aware of but may impact the performance of the model. For example, a beam/cell level measurement prediction model may perform differently if it is trained when the network was using a certain antenna pattern, antenna height, beam pattern, base station transmission power levels, and so on. Also, there could be aspects related to network load, that may have impact on the model performance (e.g., if the model predicts radio link failure, which depends on the level of interference).

Since the WTRU doesn't necessarily need to know all the details of the network side additional conditions (and network may also not want to expose some of these implementation details), the network could hide these details by signaling to the WTRU one or more configuration ID (e.g., associated ID(s)). When data is being collected for training a model, tagging may be performed indicating under which network side additional conditions the model is being trained. When a WTRU is being configured to perform the AI/ML based operation (e.g., beam and/or cell measurement prediction), the WTRU may check the consistency between the conditions under which the AI/ML model is trained on and current conditions (e.g., current WTRU conditions, current associated ID(s) signaled by the network indicating current network conditions and/or settings, etc.)

As described below, under normal conditions the WTRU may perform the AI/ML based operations if the WTRU has an AI/ML model applicable to the current WTRU and/or network side additional conditions. The WTRU, at least, may have a model that is tested to perform for the current WTRU and/or network side additional conditions. For example, the network may have communicated the current associated ID(s) of the cells that the WTRU is measuring. The WTRU has indicated that it has a model that works under the current WTRU conditions and/or associated ID(s). Based on that indication, the network may have activated the AI/ML functionality at the WTRU. However, the applicability may change while the functionality is being used (e.g., due to a change in WTRU side additional conditions such as WTRU speed and/or due to the change of the network side additional conditions (e.g., the associated ID of the serving/current cell changes, etc.).

A given AI/ML functionality may be associated with a set of KPIs and/or metrics. For example, this may be prediction accuracy, average or mean square difference between measured and predicted values, and/or F1-score, etc. A WTRU may have one or more AI/ML models for a given functionality. Each AI/ML model may have performance levels that meet different KPI thresholds (e.g., WTRU may have two models for doing RRM measurement prediction for a certain cell, where one has an accuracy level of 90% and another one with an accuracy level of 95%, etc.). Each AI/ML model may inform the network (e.g., during its capability reporting or after the capability reporting).

The term Life cycle management (LCM) is used to describe the overall management aspects of AI/ML models, such as: model training; functionality and/or model identification; model delivery and/or transfer; model inference operation; functionality and/or model selection, activation, deactivation, switching, and fallback operation, including: decision by the network (either network initiated or WTRU-initiated and/or requested to the network), decision by the WTRU (event-triggered as configured by the network, the WTRU's decision reported to the network, and/or the WTRU-autonomous either with WTRU's decision reported to the network or without it); functionality and/or model monitoring; model update; WTRU capability; data collection (for model training, for monitoring, and/or for inference, etc.).

LCM may be functionality-based LCM or model-ID based LCM. In functionality-based LCM, a network may indicate activation, deactivation, fallback, and/or switching of AI/ML functionality via 3GPP signaling (e.g., RRC, MAC-CE, and/or DCI). Models may not be identified at the network. The WTRU may perform model-level LCM. The WTRU may have one AI/ML model for the functionality. The WTRU may have multiple AI/ML models for the functionality.

In model-ID-based LCM, models may be identified at the network. The network and/or WTRU may activate, deactivate, select, switch individual AI/ML models via model ID. In the functionality based LCM, the WTRU may choose the AI/ML model to use for a certain functionality (e.g., network decides for which functionalities the WTRU can use AI/ML based operation, and/or the WTRU chooses the AI/ML model to use). In the model-ID based LCM, the network may explicitly control which particular model is used for a given AI/ML functionality. For example, the WTRU may provide details of AI/ML models and/or their capabilities. The network may determine which model to activate for a particular functionality.

The solution descriptions below may apply to both model-ID based and functionality-based LCM. That is, the solutions are related to how the WTRU may determine whether the AI/ML model is applicable for the indicated associated ID(s). For example, in the case of functionality-based LCM, the WTRU may be configured and/or requested to determine if a given functionality is valid and/or applicable. The WTRU may then determine among all the models it has for a given functionality and/or may consider the functionality applicable if at least one of the models is applicable. In another example, in the case of model-ID based LCM, the WTRU may be configured and/or requested by the network to determine whether a particular model is applicable or not.

An associated ID may be specific to a given functionality, or be applicable and/or common to more than one (or all) functionalities. The WTRU may support several AI/ML models for a given functionality (e.g., with different prediction time horizons, prediction confidence levels, processing requirements, and/or trained under and/or for operation in different frequencies, cells, location, and/or times of day, etc.).

A given AI/ML model for a certain functionality may operate in different modes (e.g., with different levels of prediction confidence levels at different prediction time horizons, at different locations, frequencies, and/or WTRU mobility pattern and/or speed, etc.)

The AI/ML models may be available at the WTRU already trained or the WTRU may be provided with an untrained AI/ML model and perform the training by itself. The AI/ML model may be available at the WTRU already trained, and the WTRU may be enabled and/or configured to perform further training (e.g., for different conditions such as frequencies, cells, location, and/or times of day, for the same conditions as the initial training but for increasing the level of confidence or/and the prediction time horizon, and/or for different WTRU speeds, etc.) In some examples, the AI/ML model may be available at the WTRU but not trained at all or only trained for certain WTRU and/or network conditions. The WTRU may be configured to train the model (e.g. for the conditions it is not trained).

All the solutions described herein are agnostic to the kind of AI/ML model and/or technique used by the WTRU (e.g., the algorithm used, the neural network used, depth, parameters, and/or weights of the network, etc.), the origins of the model (e.g., WTRU vendor, operator, and/or network vendor, etc.), or how and/or where the training of the model is done (e.g., the input data used for the training, where the training is performed, if the training is performed offline or online, etc.). However, it can be assumed that the model may be trained based on historical observation of one or more WTRUs' actual measurements in different WTRU and/or network conditions (e.g., during certain time durations of the day, during certain days of the week, at different locations, different WTRU mobility patterns and/or speeds, under different network conditions visible to the WTRU such as frequency and/or bandwidth, under different network visible to the WTRU, and/or a network configuration index provided by the network at the time of training and/or data collection, etc.).

Though the descriptions herein focus on RRM measurement prediction, all the aspects are equally applicable for other functionalities based on measurement prediction (e.g., indirect event prediction based on measurement predictions, and/or CHO based on predicted events, etc.).

While the focus of the solution descriptions below is on prediction based AI/ML models, the proposed solutions are equally applicable to any other form of prediction that does not use AI/ML (e.g. time series forecasting and/or interpolation methods, etc.).

As used throughout this disclosure, the terms “AI/ML” and “AIML” may be used interchangeably; the terms “data”, “measurements”, “report” and “results” may be used interchangeably; the terms “support” and “capability” may be used interchangeably (for example, a WTRU indicates that it supports XYZ and a WTRU indicates that it is capable of XYZ, etc.); the terms “indication”, “information”, and “message” may be used interchangeably; the terms “current cell”, “serving cell”, and “source cell” may be used interchangeably; the terms “target cell”, “candidate cell” and “neighbor/neighboring cell”, may be used interchangeably; the terms “handover” and “cell switching” may be used interchangeably; the terms functionality and procedure may be used interchangeably; the terms “execute”, “apply” and “perform” may be used interchangeably; the terms “legacy” and “non-AI/ML” may be used interchangeably; the terms “prediction” and “estimation” may be used interchangeably; the terms “configuration” and “functionality” may be used interchangeably; the terms “(sub) use case” and “(sub) functionality” may be used interchangeably; the terms “IE (information element)” and “parameter” may be used interchangeably; the term “AI/ML mobility” may be used to collectively refer to the different use cases and/or functionalities related to mobility that are enhanced via AI/ML based prediction (e.g., AI/ML based RRM measurement prediction, measurement event prediction, handover failure prediction, and/or radio link failure (RLF) prediction, etc.); the terms “measurements” and “signal levels” may be used interchangeably (e.g., predicted cell and/or beam signal levels and predicted cell and/or beam measurements, etc.).

In some of the descriptions below (for example, temporal predictions where the WTRU is doing the actual measurements as well as future predictions of a given cell and/or beam), the term “performing the measurement according to the measurement prediction configuration” may be used interchangeably to refer to both the measurement and prediction aspects.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Described herein are aspects related to capability and/or support of RRM measurement prediction. A WTRU may indicate its capability related to RRM measurement prediction. For example, a functionality ID and/or code may be defined and/or specified in 3GPP. The WTRU may indicate as much in the list of AI/ML based functionalities that it supports.

In one solution, the WTRU may indicate the type of RRM measurement prediction of which it is capable. For example, the WTRU may indicate the one or more sub-use cases discussed for the RRM measurement prediction use case. For example:

Sub-use case 1: L1 beam-level measurement result(s) is predicted based on actual L1 beam-level measurement result(s) and then L3 cell-level measurement result is generated.

Sub-use case 2: L3 Cell-level measurement result(s) is predicted based on actual L3 cell-level measurement result(s).

Sub-use case 3: L3 Cell-level measurement result(s) is predicted based on actual L1 beam-level measurement result(s).

Sub-use case 4: L1 filtered beam-level measurement result(s) is predicted based on actual L1 beam-level measurement result(s) and then L3 beam-level measurement result is generated.

Sub-use case 5: L3 beam-level measurement result(s) is predicted based on actual L3 beam-level measurement result(s).

Sub-use case 6: L3 beam-level measurement result(s) is predicted based on actual L1 beam level measurement result(s).

A sub-functionality ID and/or code may be defined and/or specified in 3GPP. The WTRU may indicate the list of the RRM measurement sub-functionalities that it supports when reporting that it supports AI/ML based RRM measurement prediction.

In the functionality and/or sub-functionality reporting of AI/ML based RRM measurement prediction capability indication described above, the WTRU may include additional information regarding the applicability. Such additional information may include, an area of applicability, cells, (e.g., in terms of lists of cells), RAN and/or/tracking area, range of geographical areas, (e.g., global navigation satellite system (GNSS) co-ordinates), cell types, (e.g., frequencies and/or BWPs, etc.), and/or time of applicability (e.g., time duration during the day).

The indication of functionality and/or sub-functionality support may include additional information related to the parameters and/or configuration under which the prediction may be performed. This may include information such as: the type of measurement prediction to performed (e.g., one of the RRM measurement prediction use cases described above); the supported measurement reduction rate(s); the supported measurement skipping pattern(s); the supported observation and/or prediction window length(s); measurement and/or prediction periodicity and/or offsets; network side additional conditions (e.g., associated ID(s)) under which the models of the WTRU are trained in); area information in which the models of the WTRU are trained (e.g., list of cells and/or tracking areas, etc.); and/or expected KPIs for the predictions (e.g., for each supported combination of parameters above).

The functionality and/or sub-functionality support and/or capability indication discussed above may apply to all the cells for which the WTRU may perform RRM measurement predictions or can be specific and/or different for different cells, or it can be specific to a subset of the cells. For example, the WTRU may indicate that it may support RRM sub-case 2 for a first subset of cells, RRM sub-case 3 for another subset of cells, etc. The WTRU may indicate that, for a given observation window length, it can predict up to a PW lengths of x for certain cells, while it may predict up to a PW length of y (e.g., where y<x) for other cells (e.g., only up to a PW length of y for other cells).

The WTRU may provide information related to the one or more network side conditions (e.g., one or more associated IDs) that its models have been trained on (for the one or more cells that it is able to perform RRM measurement prediction).

In some cases, the input to the model is the cell and/or beam signal levels of a first cell (or first group of cells) and the output of the model is the cell and/or beam signal levels of a second cell (or second group of cells). For example, if a model is trained for spatial prediction and/or inter-frequency prediction, there may be a mapping of the associated ID(s) of the input cells and/or beams and/or associated ID(s) of the predicted cells and/or beams. The WTRU may have a model trained to predict signal levels of cell x based on signal levels of cell y, and during the collection of the data for model training, the associated ID for cell x was x_ID and that of cell y was y_ID.

The functionality and/or sub-functionality support and/or capability indication discussed above may include information related to KPIs (e.g., confidence levels, accuracy, and/or F1-score, etc.). For example, if the WTRU has a model trained for different OW and/or PW window lengths (e.g., for one or more cells), the WTRU may indicate different accuracy and/or confidence levels for the different combination of supported observation and/or predicted windows.

The WTRU may indicate the support and/or capability at functionality and/or sub-functionality level (as discussed above, and as seen in FIG. 7) using the WTRU capability signaling framework. For example, the WTRU may receive a UECapabilityEnquiry message and in response to that it may send a UECapabilityInformation message indicating the supported AI/ML mobility functionalities and/or/sub-functionalities to the network.

The UECapabilityEnquiry message may indicate that the enquiry is about AI/ML mobility support. The message may not specify details such as specific cells and/or types of capabilities. The WTRU may respond by including all the supported AI/ML mobility functionalities and/or sub-functionalities and may include any additional information about the supported capabilities as discussed above.

The UECapabilityEnquiry message may include cell and/or area information (e.g., identity of one or more cells, RAN and/or tracking area, and/or frequencies, etc.). The WTRU may respond including the supported AI/ML functionalities and/or sub-functionalities for the indicated cell(s) and/or any additional information about the supported capabilities as discussed above.

The UECapabilityEnquiry message may include prediction-related information (e.g., the OW and/or PW lengths, the MRRT, and/or KPI levels, etc.). The WTRU may respond by including all the supported AI/ML mobility functionalities and/or sub-functionalities that can support such a prediction configuration (e.g., the list of cells where such a prediction can be made, etc.).

The information about the supported AI/ML mobility functionalities and/or sub-functionalities as discussed above may be provided via other signaling than WTRU capability signaling. This may be based on UEAssistanceInformation based signaling (e.g., based on one or more triggering conditions). Some of the triggering conditions (e.g., when a certain AI/ML mobility-related prediction functionality and/or configuration, not applicable before, may become applicable, etc.) are discussed in some of the solution descriptions herein.

New downlink (DL) and/or uplink (UL) RRC messages may be introduced. These RRC messages may be used for the network to request the WTRU regarding the supported AI/ML mobility related functionalities or/and sub-functionalities. The WTRU may respond to that request. For example, these could be generic messages used for requesting and/or responding about supported AI/ML functionalities and/or sub-functionalities. There may be a separate request and/or response message specific to AI/ML mobility.

The WTRU may receive an RRM measurement and/or measurement prediction configuration. The measurement prediction may be structured according to the NR measurement configuration framework (e.g., measurement object configurations, measurement reporting configurations, and/or an association of the object and/or reporting configurations via a measID, etc.).

The configuration and/or information related to the measurement prediction may contain one or more of the following information: the type of measurement prediction to performed (e.g., one of the RRM measurement prediction use cases described above); beam consolidation related configuration that considers predicted and measured beams (e.g., number and/or ratio of predicted beams to consider in the cell level measurement derivation, beam consolidation signal level threshold for the predicted beams, and/or if different from the one to be used for the measured beams, etc.). There may be use cases where beam level predictions may derive cell level measurements.

The configuration and/or information related to the measurement prediction may further include: L3 filtering configurations such as filtering coefficients to apply (e.g., for the use case where there is time domain measurement skipping, different filtering coefficients may be applied to measured and predicted beam if they are both to be used in deriving a L3 filtered measurement); OW and/or PW lengths; measurement reduction rate; skipping pattern; measurement and/or prediction periodicity and/or offsets; minimum required KPIs for the predictions; network side additional conditions (e.g., associated ID(s) for the concerned cells whose measurements is to be predicted).

The above configuration related to measurement prediction is applicable to all measurement predictions. An information element (IE) or a set of IEs may be added in the RRC MeasConfig IE that may include the above information.

The WTRU may apply the measurement prediction for all the measurement objects according to the indicated measurement prediction configuration at MeasConfig level.

For each measurement object, there may be a flag and/or IE. The flag and/or IE may indicate whether measurement prediction is to be performed. If so, the indicated measurement prediction configuration at measConfig level may be assumed.

The prediction configuration may be configured at measurement object level (e.g., in an IE and/or group of IEs in the measObjectNR IE). Within a given measurement object, there may be a list of cells where prediction is to be applied. For those cells, the prediction is to be performed according to the measurement prediction configuration indicated at MeasConfig level or measobjectNR level.

Within a given measurement object, there may be a list of cells where prediction is not to be applied (e.g., the WTRU may apply the prediction configuration at MeasConfig level or measObjectNR level to the cells outside this list). There may be an indication (e.g., an IE and/or flag) in a measurement reporting configuration indicating whether the reporting is to be based on actual measurements and/or predictions. For example, for a given measurement object, the WTRU may have two reporting configurations. One reporting configuration may have an indication if that reporting is to be based on actual measurements (e.g., only actual measurements), predicted measurements (e.g., predicted measurements only), or both actual measurements and prediction. When prediction is to be applied, the WTRU may use the prediction configuration indication at MeasConfig level or measObjectNR level.

The measurement prediction configuration may be provided at the measurement reporting configuration level (e.g., in an IE or group of IEs in the reportConfigNR).

There may be an indication (e.g., an IE and/or flag) in a measurement ID configuration that associates a measurement configuration with a reporting configuration. The indication may indicate whether prediction is to be applied. For the measurement IDs when prediction is to be applied, the WTRU may use the prediction configuration indication at MeasConfigNR level or measObjectNR or reportConfigNR level.

There may be a new IE defined, (e.g., predictionID) that is similar to measID. The new IE may associate measurement objects containing prediction configurations (and also actual measurement configurations) with reporting configurations. The association may be based on predicted measurement (and actual measurements if the associated measurement configuration contains also configuration to perform actual measurements).

There may be several configurations related to performing measurement predictions (e.g., each with an ID, provided in a configuration at the MeasConfig level or even outside the MeasConfigNR, e.g., directly as an IE in the RRCReconfiguration message). This may be used in conjunction with any of the solutions above. For example, the ID of the measurement prediction configuration may be included in the measObjectNR, reportConfigNR, and/or measID configurations. Alternatively, there may be a separate association between the measObjectNR, reportConfigNR, and/or measID and the ID of the measurement prediction configuration under the measConfigNR. This association may be similar to the measID used to associate measurement object configurations and measurement reporting configurations.

The network side additional condition (e.g., associated ID) may be part of the measurement prediction configuration. For example, there may be a common associated ID indicated at the measurement object level that is assumed for all the concerned and/or allowed cells within the measurement object. Alternatively, there may be a specific associated ID indicated for each allowed cell within the measurement object. A solution may also be envisioned where the WTRU gets the associated ID regarding a certain cell from the broadcast information of that cell (e.g., an associated ID may be included in one of the SIBs of the cells).

The measurement prediction parameters in the configuration may be indicated to be mandatory or optional. In an example, unless indicated otherwise, parameters may be considered mandatory. In another example, unless indicated otherwise, parameters may be considered optional. In another example, an explicit indication may indicate if the parameter is optional or mandatory (e.g., in the received configuration message, specified in 3GPP specification documents, e.g., TS 38.331).

When a parameter related to measurement prediction is not specified and/or indicated in the received configuration, the WTRU may freely consider one of the possible values for that parameter (e.g., based on WTRU's own criteria). There may also be a mapping (e.g., in 3GPP specifications) that indicates what value(s) may be assumed for a parameter not explicitly indicated in the received configuration based on other parameters that are configured. For example, if parameter A is not indicated, and parameter B is configured to value_b1, then assume parameter A to be value_a1. If parameter B is configured to value_b2, then assume parameter A to be equal to value_a2, and so on. There may also be default values that can be assumed for a parameter if the parameter is not explicitly indicated and/or specified in the received configuration (e.g., default value specified in 3GPP technical specification).

The parameters and/or IEs for a measurement prediction may not necessarily equal to a certain value (e.g., MRRT=50%). Alternative values may include: inequality condition (e.g. MRRT>75%); range condition (e.g. MRRT in [50%, 75%]); and/or a SELECT ANY condition (MRRT={50%, 75%, 90%}).

A combination of multiple parameters and possible values may also be configured. For example, parameter1 less than value_p1_1 and parameter2 within a first range of values, or parameter 1 greater than value_p1_1 and parameter2 within a second range of values, etc.

The WTRU may be configured with a separate measurement prediction object for prediction related aspects. This measurement prediction object may be separate from measurement object for actual measurements. The skipping, MRRT, OW, and/or PW configurations may be based on existing measurement gap and/or SSB based RRM measurement timing condition (SMTC) like configurations, or they may be new configuration.

In legacy NR, where there is no support for AI/ML based functionalities, the network may have complete knowledge of the capabilities of the WTRU. Thus, whenever the WTRU receives an RRC reconfiguration message, the network may try to apply the configuration. An unsuccessful attempt by the network, (e.g., the network was trying to configure the WTRU beyond its capabilities, e.g., more measurements than it can perform at once, measurements of frequencies/bands the WTRU is not able to measure, etc.), may result in an RRC reconfiguration failure (which can be considered as one type of radio link failure). The RRC reconfiguration failure may require subsequent connection re-establishment.

In the context of AI/ML based mobility support, the network may not have all the detailed information about the supported measurement and/or event prediction capabilities. The network may not have the conditions (e.g., WTRU side additional conditions and/or network side additional conditions, etc.) under which the AI/ML mobility functionalities and/or sub-functionalities are applicable. Even if the WTRU has provided detailed information about the supported functionalities and/or/sub-functionalities to the network, the network may not have an up-to-date information regarding the current WTRU side additional conditions, such as WTRU speed. Thus, the WTRU may not be able to apply and/or compile all or a subset of the measurement and/or event prediction configurations.

A WTRU, upon the reception of an RRM measurement configuration that contains prediction related information according to any of the solutions above, may determine if the prediction related configurations are currently applicable. The WTRU may make this determination if the WTRU has at least one AI/ML model that fulfills one or more of the following: the model has been trained for the current WTRU conditions (e.g., WTRU speed); the model has been trained for the indicated network conditions (e.g., the indicated associated ID(s)) for the concerned cells and/or beams that the WTRU is being configured to do the predictions; the model can operate under the indicated MRRT(s), skipping pattern(s), OW and/or pw lengths; and/or the model is expected to perform to the indicated level (according to the one or more indicated performance level, KPI, and/or thresholds).

If a measurement prediction parameter is configured to be mandatory (explicitly or implicitly as discussed above), the WTRU may have a model that satisfy that parameter value for performing its prediction for the WTRU to consider the prediction configuration to be applicable. If a measurement prediction parameter is configured to be optional (explicitly or implicitly as discussed above), the WTRU may consider the prediction configuration to be applicable even if the parameter value cannot be configured and/or used by its models. For example, if a measurement prediction parameter A (e.g. MRRT=75%) is indicated as mandatory (e.g. to be fully satisfied), while parameters B (a specific measurement skipping pattern) is designated as optional, the WTRU may be configured to consider the configuration applicable if it has a model that satisfies A but not B.

Having a mismatch between a configured and a supported measurement prediction parameter is a necessary but not sufficient condition to determine partial and/or non-applicability. The determination may consider whether that mismatch would lead to deterioration in the inference accuracy of the AI/ML model. As an example, requesting a smaller PW than the one that may be supported by a WTRU's AI/ML model may not necessarily lead to partial and/or non-applicability. The WTRU may predict the configured (e.g., during training) number of RRM samples but report (e.g., only report) the requested number (e.g., and so, even with a better KPI that it may have associated with the prediction of a longer window length).

There may be examples of cases that may lead to full applicability (e.g., or may not impact the applicability of the requested functionality or the inference accuracy of the AI/ML model the WTRU has) despite a mismatch between a configured and the supported prediction parameter (e.g., or supported and current WTRU conditions). Such examples may include: if the requested length of PW is smaller than the supported one; if the requested measurement periodicity within the PW and/or observation window is larger than what the WTRU supports; if the requested MRRT is lower than what can be supported; if the measurement skipping pattern is different from the patterns the WTRU can support; and/or if the current WTRU speed is lower than the supported WTRU speed (e.g., if a model that is trained at high WTRU speed may be able to do inference at a lower speed with an acceptable accuracy).

The concept of a weak applicability may also be introduced. For a given measurement prediction configuration, the WTRU may not have a model that is trained and/or tested for that configuration (e.g., and current WTRU conditions) but the difference between the supported parameter and the configured parameter (e.g., or the supported WTRU condition) may be marginal. The WTRU may have an AI/ML model trained for RRM prediction for a range of WTRU speeds. The current WTRU speed may fall outside of that range, but the difference may be marginal. For example, the difference may be smaller than the minimum of the supported speeds by less than a certain threshold and/or not greater than by a certain threshold compared to the maximum of the supported speeds. As another example, the WTRU may have a model trained for a cell operating at a certain frequency and/or in a range of frequencies. The frequency of the cell the WTRU is requested to perform measurement prediction may fall outside the supported frequencies or the range of frequencies, but the difference may be marginal. For example, the difference may be smaller than the minimum of the supported frequencies by less than a certain threshold and/or not greater than by a certain threshold compared to the maximum of the supported frequencies. In these cases, the model can be considered to have weak applicability.

In case of weak applicability, prediction monitoring may be performed for a certain duration before the WTRU may consider the configuration to be applicable or not. The WTRU may perform both prediction and/or actual measurements for a certain duration and/or compare the accuracy of the predictions to a certain configured KPI.

The measurement prediction configuration may be provided at a cell level and/or may be common to multiple cells. The measurement prediction configuration may be common if the prediction configuration is provided in a measurement object that does not have a blocked and/or allowed cells list or it contains an allowed cells list that contains more than one cell. Thus, in some cases, a measurement reporting may partially apply. For example, applicability may be to cell x and y, but not z, where cells x, y, and z were in the allowed list of a measurement object and/or the prediction configuration was provided at the measurement object level.

The WTRU may have received a measurement prediction configuration for more than one cell (e.g., provided at measobjectNR level). The WTRU may perform the applicability determination of the measurement prediction configuration for all the concerned and/or associated cells on a cell-by-cell basis. The WTRU may be provided with a measurement object configuration that has a measurement prediction configuration that indicates cells x and y in the allowed cells list. The WTRU may indicate an associated ID of 1 for cell x and/or associated ID of 2 for cell y. The WTRU may have, by itself, determined the associated IDs of the cells by reading the broadcast signaling from these cells. The WTRU may determine if the configuration is applicable for cell x but not cell y (e.g., if the WTRU has a model trained for associated ID 1, such as only for associated ID 1).

The WTRU may consider RRM measurement prediction applicable if the WTRU can do measurement prediction for all the neighbor and/or serving cells that the WTRU is configured to measure and/or predict. The WTRU may consider RRM measurement prediction applicable (e.g., only) if the WTRU can do measurement prediction for at least a certain number of (e.g., or percentage of) the neighbor and/or serving cells that the WTRU is configured to measure/predict. The WTRU may consider RRM measurement prediction applicable (e.g., only) if the WTRU can do measurement prediction for even one of the neighbor and/or serving cells that the WTRU is configured to measure and/or predict.

The applicability report may be an RRC message. For example, the applicability report may be a new RRC message, and/or an additional information included in an RRC Reconfiguration Complete message sent as a response to the RRC message that configured the measurement prediction as discussed above.

The applicability report may include an indication that the measurement prediction configuration is fully applicable. (e.g., if the measurement prediction configuration is provided at the measurement object level, the fully applicability indication means that the WTRU can do the measurement prediction for all the cells that are associated with the measurement object).

The applicability report may include an indication that the measurement prediction configuration is fully not applicable for a given measurement object. The applicability report may include an indication that the measurement prediction configuration is partially applicable for a given measurement object. If the applicability report includes an indication that the measurement prediction configuration is partially applicable for a given measurement object, it may include the list of the allowed and/or concerned cells of this measurement object where the prediction is applicable. If the applicability report includes an indication that the measurement prediction configuration is partially applicable for a given measurement object, it may include the list of the allowed and/or concerned cells of this measurement object where the prediction is not applicable.

The applicability report may contain multiple lists. For example, a first list containing the identities of the configurations that are fully applicable, a second list containing the identities of the configurations that are fully non-applicable, and/or a third list containing the identities of the configurations that are partially applicable. If the prediction configuration was provided at a measurement object level, the configuration identities may correspond to measurement object identities. For example, if the prediction configuration was provided at measurement ID level, then the configuration identities may correspond to the measurement IDs.

The applicability report may contain a list of cells and/or an indication if the measurement prediction configured for that cell is currently applicable or not.

Variants of all the above solutions may be envisioned where, if a non-applicability is being indicated, the WTRU may include the reason why the configuration is not applicable (e.g., via a cause value). For example, the cause value may take one or more of the following: no model available for the concerned AI/ML mobility function or sub-functionality; a model is available, but it is not trained yet (e.g., model structure available, but not trained); a model is available, and is trained, but not trained for the concerned cell; a model is available, and is trained for the concerned cell, but not for an associated ID of the cell (e.g., as indicated in the prediction configuration, as determined by the WTRU via reading the broadcast signal of the cell, etc.); a model is available, and is trained for the concerned cell and/or for associated ID of the cell, but not for the current WTRU conditions (e.g., WTRU speed); a model is available, and is trained for the concerned cell, the associated ID of that cell, and/or for the current WTRU conditions, but is not compatible with the configured measurement parameters (e.g. MRRT, and/or OW/PW, etc.); and/or a trained model is available and is capable of supporting the indicated prediction parameters and current WTRU and/or network conditions, but not able to provide the required KPI level.

In case there were optional and/or unspecified parameters in the measurement prediction configuration, as discussed above, the WTRU may indicate the chosen values for those parameters in the applicability report (e.g., if MRRT was configured to be optional, the WTRU may indicate the value of the MRRT it is going to use). In case the WTRU can support a better measurement prediction (e.g., higher MRRT and/or longer PW, etc.) than the one indicated in the received prediction configuration, the WTRU may use the better value instead and/or indicate those values in the applicability report.

The WTRU may send the applicability report. The applicability report may contain information about full applicability, no applicability, and/or partial applicability for each prediction configuration as discussed above. The WTRU may wait for a subsequent message from the network (e.g., an RRC message and/or a medium access control (MAC) control element (CE), etc.) to start performing those predictions.

The WTRU may apply the measurement prediction configuration and/or start performing the measurement prediction according to the configuration for any cell where the configuration is determined to be applicable. The WTRU may not wait for further indication from the network regardless of how the configuration was signaled for that cell. For example, if the configuration was provided at measurement object level that has two allowed cells configured, and the WTRU has determined the configuration is applicable to the first cell but not the second cell, then the WTRU may start the measurement prediction for the first cell immediately.

If the measurement prediction configuration is common to multiple cells and/or is partially applicable (e.g., applicable only to some of the cells), the WTRU may not start performing the predictions. This may apply even for the cells where the prediction configuration is applicable. Instead, the WTRU may send the partially applicability report to the network and/or wait for a subsequent message to enable and/or trigger the prediction for the applicable cells.

If the measurement prediction configuration is common to multiple cells and/or is partially applicable (e.g., applicable only to some of the cells), the WTRU may not start conducting the predictions for the cells where the prediction configuration is applicable. If a certain percentage and/or number of the cells using these prediction configuration is applicable, the WTRU may start the predictions.

If the measurement prediction configuration for a given cell is not applicable, the WTRU may use other information in the measurement configuration to perform the actual measurements instead of the predictions. For example, the measurement prediction configuration may relate to measurement skipping for the goal of MRRT. The WTRU may determine that no model is applicable for the concerned cell to perform such measurement prediction and achieve the desired MRRT. The WTRU may then ignore the prediction part of the measurement configurations and may perform the (legacy) RRM measurement for that cell.

There are AI/ML model architectures that may process varying lengths of OWs, as well as generate inference for varying lengths of PWs. For example, a convolutional neural network (CNN) model may support variable lengths of OWs that depend on the shape of its kernel at the first convolutional layer. Other examples may include models that may have outputs of variable lengths branching out of the network at different depths of the network (at different layers). Therefore, there may not be a one-to-one mapping between a physical AI/ML model (model ID) and a configuration of measurement parameters. In addition, the WTRU may have AI/ML models that support various combinations of the configuration parameters. For example, the WTRU may have models supporting the same MRRT using different skipping patterns and/or may have various models supporting varying degrees of MRRT.

Multiple AI/ML models and/or parameter configurations may satisfy the requested parameters. Assuming the other conditions determining applicability are also satisfied (e.g. WTRU-side and/or NW-side conditions), the WTRU may select which AI/ML model and/or parameter configuration to use. The model may base this determination on its own criteria, which may include one or more of the following: select the most accurate AI/ML model (based on the WTRU's own pre-computed KPIs); select the AI/ML model with the largest inference speed, to reduce prediction latency; and/or select the most computationally efficient AI/ML model to preserve the WTRU's battery.

If the NW requests a list of MRRT (select any condition), one WTRU may select to implement the highest MRRT in the list. The WTRU may make this selection potentially at the expense of inference accuracy if the goal is to skip a larger number of measurements. For the same example, another WTRU may select a lower MRRT, if the target of that WTRU is to have more accurate inference at the cost of additional measurements.

For the intra-frequency measurement prediction cases, if measurement is performed instead of prediction (e.g., due to non-applicability), then a WTRU may conduct the measurements and not the prediction. The WTRU may perform this way as the WTRU has everything needed to perform the measurements. The WTRU may have skipped performing some measurements if prediction was applicable.

For the inter-frequency cases, a WTRU may be provided with a measurement gap configuration. The measurement gap configuration may be used in case prediction is not applicable. The WTRU may not apply the gaps and/or start measuring immediately before informing the network. Such action may cause problems if the network did not assume the WTRU will use the gaps and conduct the predictions. Another alternative is for the network to pessimistically assume prediction is not possible (and thus consider the measurement gap will be applied by the WTRU). In the case where prediction is not applicable, the WTRU may use the gap (e.g., immediately use the gap). In the case where prediction is applicable, the WTRU may provide the applicability in the applicability report. Thus, the network may understand that the WTRU is not using the gap (e.g., may schedule the WTRU during the time durations where the gap was configured to be).

The WTRU may receive a subsequent message from the network as a response to the applicability report. As discussed above, the WTRU may send a partial applicability report and/or wait for a subsequent message from the network to enable the measurement prediction for those cells. Measurement prediction may be performed based on the measurement prediction configuration. Also, even for the case of full applicability, the WTRU may send (e.g., only send) the applicability report and/or enable the predictions on a confirmation from the network.

The WTRU may receive one indication that indicates the WTRU should start performing the predictions for all the cells where the configuration is applicable. The WTRU may receive an indication to enable and/or start the prediction for a particular measurement prediction configuration (e.g., measurement object ID, meas ID, report config ID, etc. depending on the how the measurement prediction configuration was signaled). The prediction configuration may indicate that the WTRU should start performing the predictions for all the cells corresponding to the configuration (e.g., all the applicable cells within the indicates measurement object ID).

The WTRU may receive an indication to enable and/or start the prediction for a particular cell regarding which the WTRU has explicitly or implicitly indicated that the measurement prediction is applicable according to any of the solutions herein. The WTRU may start performing the measurement prediction and/or reporting for all the cells measurement prediction is enabled according to any of the solutions herein. The WTRU may monitor and/or determine when a prediction configuration that was not applicable (as indicated explicitly or implicitly in the applicability report) becomes applicable. The details of this proactive applicability determination and reporting is described herein. The WTRU may monitor and/or determine when a prediction configuration that was applicable (as indicated explicitly or implicitly in the applicability report) becomes applicable. The details of this proactive applicability determination and reporting is described herein.

Disclosed herein are solutions for proactive applicability determination and/or reporting. A WTRU may monitor applicability changes (e.g., from non-applicability to applicability or vice versa) for one or more cells within one or more measurement objects and/or to provide applicability updates. The WTRU configuration may include one or more of: conditions to determine when a functionality becomes applicable, non-applicable and/or partially applicable (e.g., model availability, consistency between model training conditions and/or current conditions, and/or required performance level for one or more cells); how often or when the monitoring should be done; and/or when to send the applicability report.

All conditions to determine when a functionality becomes applicable, non-applicable and/or partially applicable may be fixed and/or specified in 3GPP specification (e.g., the WTRU may not need to receive the conditions explicitly). The WTRU may need to receive a subset of the conditions explicitly (e.g., required performance level).

The configuration regarding applicability change may be received by the WTRU even before the measurement prediction configuration is received. For example, the WTRU may send the applicability report when the conditions for reporting the applicability report are fulfilled. The network may have used that information to determine the measurement prediction configuration.

The WTRU may be configured as part of the measurement prediction configuration, after the measurement prediction configuration, and/or when the WTRU has reported initial applicability report as described in any of the solutions above, etc. The WTRU may monitor the applicability changes of those configurations and/or functionalities that may have not been applicable at the reception of the configuration and/or report when and/or if they become applicable.

The WTRU may be configured as part of the measurement prediction configuration, after the measurement prediction configuration, and/or when the WTRU has reported initial applicability report as described in any of the solutions above, etc. The WTRU may monitor the applicability changes of those configurations and/or functionalities that may have been applicable at the reception of the configuration and/or report when and/or if they become non-applicable.

The WTRU may monitor the applicability of a subset of the measurement configurations, objects, and/or cells. The WTRU may determine and/or monitor the change from non-applicability to applicability for a subset of the configurations, objects, and/or cells that it has indicated as non-applicable in a previous applicability report. For example, the WTRU may determine and/or monitor the change from applicability to non-applicability for a subset of the configurations, objects, and/or cells that it has indicated as applicable in a previous applicability report.

Even if the WTRU has indicated that a configuration and/or object is applicable (or that the WTRU can do the prediction according to the configuration for a given cell and/or cells), the network may not activate and/or enable the prediction according to the prediction configuration. The WTRU may be configured to monitor the change from applicability to non-applicability for the active prediction configurations (e.g., only the active prediction configurations) and/or objects (or the cells who measurements the WTRU is predicting).

The WTRU may monitor the applicability and/or non-applicability of the indicated prediction measurement configurations. The WTRU may report any applicability changes according to the requested monitoring and/or reporting configuration.

The WTRU may monitor applicability conditions in a periodic manner. For example, the WTRU may check for applicability determination every x seconds, even if WTRU-side and/or NW-side conditions remain the same, and/or no part of the measurement prediction configuration has been modified.

The WTRU may be provided with a proactive monitoring periodicity (e.g., x seconds) that is common to all measurement prediction configurations. Such prediction configurations may include all prediction measurement objects and/or all concerned cells. The WTRU may perform the applicability determination accordingly (e.g., every x seconds).

Different monitoring periodicities may be configured for different measurement prediction configurations (or for a set of measurement prediction configurations). The WTRU may conduct the applicability monitoring and/or determining for a measurement prediction configuration according to the corresponding monitoring periodicity for that measurement prediction configuration.

The periodicity may be the same for all measurement prediction objects. Different periodicities may be defined for each measurement object. The WTRU may be configured with a common periodicity for all the cells within a measurement prediction object. Different periodicities may be requested for one or more of the cells in the cell list of the measurement object. The periodicity for applicability change determination is the same for applicable, non-applicable, and/or partially applicable configurations.

The periodicity may be different between applicable, non-applicable, and/or partially applicable configurations. For example, the network may configure a higher periodicity for monitoring of an applicability change of an applicable configuration (e.g., to determine if an applicable configuration has become non-applicable or partially applicable) as compared to the periodicity it uses to determine the applicability change of a non-applicable configuration (e.g., to determine if a non-applicable configuration has become applicable).

Different periodicities may be configured for different sub-functionalities. A common periodicity may be configured for all supported sub-functionalities.

The WTRU may monitor applicability in an event-based manner. For example, the WTRU may monitor for a change in WTRU-side conditions, NW-side conditions, and/or some parameters of the measurement prediction configuration. This may be a one-time check and/or performed for a certain duration after the change is detected (e.g., for a certain duration at a given periodicity). The WTRU may be configured with periodicity X1 to check whether its speed has exceeded a threshold speed. Once this happens, the WTRU may perform applicability change determination/monitoring with periodicity X2.

The WTRU may perform applicability determination upon a change in the supported configuration of the measurement prediction parameters for one or more cells within one or more measurement objects. For example, a new AI/ML model may become available at the WTRU, and/or an existing AI/ML model may have been retrained and/or finetuned to support for additional configurations of parameters (e.g. MRRT, OW, and/or PW) that may change non-applicable and/or partially applicable measurement objects into partially applicable and/or applicable and may also change non-applicable cells into applicable. The deactivation of an existing AI/ML model associated with applicable and/or partially applicable configurations for one or more cells and/or measurement objects may lead these configurations to change into partially applicable and/or non-applicable.

The WTRU may be configured so that changes in the current WTRU conditions trigger proactive applicability determination on a measurement object and/or cell level. For example, a change in the speed of the WTRU may lead an applicable measurement object to become non-applicable and/or partially applicable (e.g., non-applicable for some of the cells associated with the measurement object). A change in the WTRU speed may lead certain applicable cells to become non-applicable and/or other non-applicable cells to become applicable.

The change of WTRU conditions may be defined based on a difference and/or delta between the current WTRU conditions and the WTRU conditions of the previous applicability determination and/or reporting. For example, the WTRU may perform an applicability determination when the WTRU speed changes by more than 5% compared to the speed the WTRU had in the previous applicability determination.

The WTRU may perform proactive applicability determination when a current WTRU condition is equal to, larger than, or smaller than a given threshold. The WTRU may perform applicability determination when the WTRU current speed is above x km/h as at that speed there may be an inconsistency between the training and inference configurations of the relevant AI/ML model.

The WTRU may perform proactive applicability determination depending on the measurements and/or predicted measurements of the current serving cell. For example, the WTRU may be configured to not conduct an applicability determination (e.g., for all measurement prediction objects, all concerned cells, a subset of the measurement objects, and/or a subset of the cells, etc.) if the signal level of the serving cell is above a certain RSRP threshold. The WTRU may conduct the applicability determination (e.g., for all the measurement prediction objects, all concerned cells, a subset of the measurement objects, and/or a subset of the cells, etc.) if the signal level of the serving cell is below a certain RSRP threshold.

In one solution, the WTRU is configured to perform proactive applicability determination/reporting upon detecting a change in associated ID (e.g., as detected by the reception of a dedicated or broadcast message) for one or more cells defined in one or more configured measurement prediction objects.

The WTRU may consider a time to trigger (TTT), during which the applicability and/or non-applicability conditions may be fulfilled to consider the received measurement prediction configuration (e.g. at measurement object level, and/or at cell level, etc.) to be considered applicable or not applicable. If a TTT value of X seconds (e.g., 10 seconds) is configured, the WTRU may consider the configuration applicable if the applicability conditions are fulfilled for the whole TTT duration. Similarly, for an applicable configuration, the WTRU may consider the configuration not applicable anymore if the conditions for applicability are not fulfilled for the whole TTT duration.

The TTT for determining a change from applicability to non-applicability may be the same as the TTT for determining a change from non-applicability to applicability, and/or different values can be configured for each. Different TTT values may be configured for different configurations (e.g., measurement object) or even for different cells within a given configuration.

The WTRU may send applicability change reports periodically (e.g., at the same or different periodicity as the monitoring periodicity). Like the monitoring periodicity, different reporting configurations may be configured for different measurement predictions configurations (e.g., measurement objects). Different reporting configurations may be configured for different cells with measurement prediction configurations. Also, Different reporting periodicities may be configured for reporting a change from applicability to non-applicability as compared to a change from non-applicability to applicability.

The WTRU may send applicability change if there is one or more configurations (e.g., measurement objects and/or cells within a measurement object, etc.) whose applicability has changed (e.g., from applicable to non-applicable or vice versa). For example, the WTRU may conduct the reporting even if one measurement object configuration's applicability has changed (or even if only one cell within the measurement object's configuration has its applicability changed. The WTRU may do the reporting if the prediction configuration becomes applicable for all the concerned cells of a given measurement prediction configuration.

The proactive applicability determination and/or reporting configuration is valid until the WTRU receives a message and/or indication indicating the release and/or disabling of the configuration. For example, the WTRU may continue to conduct the applicability determination and/or reporting according to the configuration until it receives an indication to release and/or disable such functionality. This behavior and/or configuration may be the same for all functionalities and/or configured for certain functionalities.

The WTRU may be provided with a time duration (e.g. Tx) value along with the proactive applicability determination and/or reporting configuration. The time duration value may indicate that the configuration is valid for that duration. For example, the WTRU may continue to conduct the applicability determination and/or reporting according to the configuration until that time duration has elapsed, but will stop doing so afterwards. This behavior and/or configuration may be the same for all functionalities and/or configured for certain functionalities. Also, if configured for certain functionalities, the time duration value may be different for the different functionalities.

The WTRU may be provided with a threshold value for the number of times an applicability report may be sent with the proactive applicability determination and/or reporting configuration. For example, if the threshold was set to 2, the WTRU may stop conducting the applicability determination and/or reporting after having sent 2 applicability reports (e.g. reports that were triggered due to this proactive applicability determination and/or reporting configuration. This behavior and/or configuration may be the same for all functionalities and/or configured for certain functionalities. Also, if configured for certain functionalities, the threshold value for the maximum number of reporting may be different for the different functionalities.

The WTRU may be configured with a prohibit timer. The prohibit timer may indicate the minimum time duration between sending two applicability or non-applicability (change) reports. The WTRU may be configured with a maximum number of applicability and/or non-applicability (change) reports that it sends in relation to one proactive applicability determination and/or reporting configuration and/or request.

The WTRU may be configured with a maximum time duration. The proactive applicability determination and/or reporting configuration and/or request may be considered valid after the reception of the configuration and/or request. After that time has elapsed, the WTRU may consider the request to be invalid and/or deactivated. The WTRU may even release and/or delete the configuration.

The WTRU may continue performing the proactive applicability determination and/or reporting until an explicit message is received from the network. The message may disable and/or release the configuration and/or request.

The WTRU may be enabled and/or activate measurement prediction for a given measurement object when the WTRU determines the applicability of the measurement object has changed from non-applicable to applicable. Even in the case of partial applicability, the WTRU may enable the measurement prediction for those cells where the prediction configuration has become applicable.

The WTRU may disable and/or deactivate the measurement prediction for a given measurement object when the WTRU determines the applicability of the measurement object has changed from applicable to non-applicable. Even in the case of partial applicability, the WTRU may disable and/or deactivate the measurement prediction for those cells where the prediction configuration has become non-applicable.

What is claimed is:

1. A wireless transmit/receive unit (WTRU) comprising:
a processor and memory, the processor configured to:
send a capability report, wherein the capability report comprises information associated with a capability of the WTRU to perform a radio resource management (RRM) measurement prediction associated with one or more artificial intelligence or machine learning (AI/ML) models;
receive a measurement prediction configuration, the measurement prediction configuration comprising a first indication, wherein the first indication indicates that the WTRU is to perform RRM measurements for one or more cells or that the WTRU is to predict RRM measurements for one or more cells, wherein the measurement prediction configuration comprises one or more measurement objects, wherein each of the one or more measurement objects comprises information associated with one or more cells associated with the RRM measurements to be performed or to be predicted and information indicating how the prediction is to be performed;
determine applicability of the WTRU to perform predictions for RRM measurements using the one or more AI/ML models on each of the one or more cells based on the first indication indicating that a RRM measurement is to be predicted;
send an applicability report, wherein the applicability report comprises a second indication indicating that the WTRU can perform the predictions for RRM measurements for the one or more cells or the one or more measurement objects based on the first indication indicating that the RRM measurement is to be predicted;
perform RRM measurements associated with each of the one or more cells based on the first indication indicating that the RRM measurement is to be performed and based on the measurement objects and the information associated with the RRM measurements to be performed;
perform RRM measurement predictions associated with each of the one or more cells based on the measurement objects information associated with the RRM measurements to be predicted; and
send a measurement report indicating the RRM measurements associated with each of the one or more cells and the predicted RRM measurements associated with each of the one or more cells.

2. The WTRU of claim 1, wherein the processor is further configured to:
receive, after the WTRU sends the capability report, a configuration indicating the one or more cells that the RRM measurement is to be predicted.

3. The WTRU of claim 2, wherein the processor is further configured to:
monitor the applicability of the one or more AI/ML models to predict RRM measurements on each of the one or more cells; and
send an applicability change report, wherein the applicability change report comprises updates to the applicability of the one or more AI/ML models on each of the one or more cells.

4. The WTRU of claim 1, wherein the information associated with the capability of the WTRU to perform a RRM measurement prediction comprises one or more of an indication the WTRU can perform AI/ML prediction for the one or more cells, a list of the one or more cells, tracking areas, measurement reduction rate (MRRT) skipping patterns, observation window (OW) lengths, or prediction window (PW) lengths.

5. The WTRU of claim 1, wherein the information associated with the RRM measurements to be performed or to be predicted comprises one or more of cell level measurement derivation parameters, L3 filtering coefficients, L3 filtering parameters, a measurement reduction rate (MRRT), a measurement skipping pattern, a measurement skipping periodicity, a measurement skipping offset, observation window (OW) lengths, prediction window (PW) lengths, OW periodicity, a PW periodicity, an OW offset, a PW offset, one or more cell identifiers (IDs) for the one or more cells the RRM measurement is to be performed, one or more cell IDs for the one or more cells the RRM measurements is to be predicted, one or more associated IDs for the one or more cells the RRM measurements it be predicted that is related to network configurations, or a minimum performance level for the RRM measurement to be predicted.

6. The WTRU of claim 5, wherein the cell level measurement derivation parameters comprise measured cell or beam signal levels and predicted cell or beam signal levels, and wherein the L3 filtering parameters comprise measured cell or beam signal levels and predicted cell or beam signal levels.

7. The WTRU of claim 1, wherein the one or more AI/ML models are determined to be applicable based on one or more of the AI/ML model being configured to perform RRM measurement prediction, the AI/ML model being trained for current WTRU conditions, the AI/ML model being trained to a specific area associated with the one or more cells the RRM measurement is to be predicted, the AI/ML model support for measurement prediction related parameters, or tests performed by the AI/ML model used to provide key performance indicators (KPIs).

8. The WTRU of claim 1, wherein the measurement prediction configuration further comprises one or more reporting configurations associated with the one or more measurement objects and one or more measurement identifiers (IDs).

9. The WTRU of claim 8, wherein the one or more reporting configurations comprise one or more of periodicity, event thresholds, time to trigger (TTT), hysteresis, or conditional handover (CHO) configuration.

10. The WTRU of claim 1, wherein the applicability report further comprises a third indication that RRM measurement is to be predicted based on a configuration of the one or more measurement objects.

11. A method performed by a wireless transmit/receive unit (WTRU), the method comprising:
sending a capability report, wherein the capability report comprises information associated with a capability of the WTRU to perform a radio resource management (RRM) measurement prediction associated with one or more artificial intelligence or machine learning (AI/ML) models;
receiving a measurement prediction configuration, the measurement prediction configuration comprising a first indication, wherein the first indication indicates that the WTRU is to perform RRM measurements for one or more cells or that the WTRU is to predict RRM measurements for one or more cells, wherein the measurement prediction configuration comprises one or more measurement objects, wherein each of the one or more measurement objects comprises information associated with one or more cells associated with the RRM measurements to be performed or to be predicted and information indicating how the prediction is to be performed;
determining applicability of the WTRU to perform predictions for RRM measurements using the one or more AI/ML models on each of the one or more cells based on the first indication indicating that a RRM measurement is to be predicted;
sending an applicability report, wherein the applicability report comprises a second indication indicating that the WTRU can perform the predictions for RRM measurements for the one or more cells or the one or more measurement objects based on the first indication indicating that the RRM measurement is to be predicted;
performing RRM measurements associated with each of the one or more cells based on the first indication indicating that the RRM measurement is to be performed and based on the measurement objects and the information associated with the RRM measurements to be performed;
performing RRM measurement predictions associated with each of the one or more cells based on the measurement objects information associated with the RRM measurements to be predicted; and
sending a measurement report indicating the RRM measurements associated with each of the one or more cells and the predicted RRM measurements associated with each of the one or more cells.

12. The method of claim 11, further comprising:
receiving, after the WTRU sends the capability report, a configuration indicating the one or more cells that the RRM measurement is to be predicted.

13. The method of claim 12, further comprising:
monitoring the applicability of the one or more AI/ML models to predict RRM measurements on each of the one or more cells; and
sending an applicability change report, wherein the applicability change report comprises updates to the applicability of the one or more AI/ML models on each of the one or more cells.

14. The method of claim 11, wherein the information associated with the capability of the WTRU to perform a RRM measurement prediction comprises one or more of an indication the WTRU can perform AI/ML prediction for the one or more cells, a list of the one or more cells, tracking areas, measurement reduction rate (MRRT) skipping patterns, observation window (OW) lengths, or prediction window (PW) lengths.

15. The method of claim 11, wherein the information associated with the RRM measurements to be performed or to be predicted comprises one or more of cell level measurement derivation parameters, L3 filtering coefficients, L3 filtering parameters, a measurement reduction rate (MRRT), a measurement skipping pattern, a measurement skipping periodicity, a measurement skipping offset, observation window (OW) lengths, prediction window (PW) lengths, OW periodicity, a PW periodicity, an OW offset, a PW offset, one or more cell identifiers (IDs) for the one or more cells the RRM measurement is to be performed, one or more cell IDs for the one or more cells the RRM measurements is to be predicted, one or more associated IDs for the one or more cells the RRM measurements it be predicted that is related to network configurations, or a minimum performance level for the RRM measurement to be predicted.

16. The method of claim 15, wherein the cell level measurement derivation parameters comprise measured cell or beam signal levels and predicted cell or beam signal levels, and wherein the L3 filtering parameters comprise measured cell or beam signal levels and predicted cell or beam signal levels.

17. The method of claim 11, wherein the one or more AI/ML models are determined to be applicable based on one or more of the AI/ML model being configured to perform RRM measurement prediction, the AI/ML model being trained for current WTRU conditions, the AI/ML model being trained to a specific area associated with the one or more cells the RRM measurement is to be predicted, the AI/ML model support for measurement prediction related parameters, or tests performed by the AI/ML model used to provide key performance indicators (KPIs).

18. The method of claim 11, wherein the measurement prediction configuration further comprises one or more reporting configurations associated with the one or more measurement objects and one or more measurement identifiers (IDs).

19. The method of claim 18, wherein the one or more reporting configurations comprise one or more of periodicity, event thresholds, time to trigger (TTT), hysteresis, or conditional handover (CHO) configuration.

20. A wireless transmit/receive unit (WTRU) comprising:
a processor and memory, the processor configured to:
receive a measurement prediction configuration, the measurement prediction configuration comprising a first indication that indicates that the WTRU is to perform radio resource management (RRM) measurements for one or more cells or that the WTRU is to predict RRM measurements for one or more cells, wherein the measurement prediction configuration comprises one or more measurement objects, wherein each of the one or more measurement objects comprises information associated with the one or more cells associated with the RRM measurements to be performed or to be predicted and information indicating how the prediction is to be performed;
send an applicability report, wherein the applicability report comprises a second indication indicating that the WTRU can perform the prediction for RRM measurements for the one or more cells or the one or more measurement objects;
perform RRM measurements associated with the one or more cells based on the first indication indicating that the RRM measurement is to be performed and based on the measurement prediction configuration;
perform RRM measurement predictions associated with each of the one or more cells based on the measurement prediction configuration; and
send a measurement report indicating the RRM measurements associated with the one or more cells and the predicted RRM measurements associated with the one or more cells.
